(19) United States
(12) Patent Application Publication
(10) Pub. No.: US 2026/0340488 A1
(43) Pub. Date: Oct. 29, 2026

(54) SELECTION OF ARTIFICIAL INTELLIGENCE-BASED MODEL VARIANT IN DISTRIBUTED NODES

(71) Applicant: Dell Products L.P., Round Rock, TX (US)

(72) Inventors: John Bradley Deforge, Chelsea (CA); Dora Boviz, Ottawa (CA)

(21) Appl. No.: 19/190,300

(22) Filed: Apr. 25, 2025

(51) Int. Cl. G06N 20/00

(52) U.S. Cl. CPC G06N 20/00

(57) ABSTRACT

Selection of node-specific trained AI-based models utilized by distributed nodes (DNs) can be managed. Data processor can determine conditions associated with DN of communication network based on analyzing condition information relating to conditions associated with DN. Based on the conditions, respective metadata items associated with respective models of a group of models, comprising a first model and second model, associated with DN, and defined DN performance criteria, a model selector of the DN can determine whether to transition from having the distributed node utilize first model to utilizing second model to perform operations of the DN, wherein the respective metadata items can indicate which of the respective models is to be utilized under respective conditions associated with the DN. If second model is determined to be the most desirable model of model group, model selector can control the transition from first model to second model.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise determining, by a system comprising at least one processor, conditions associated with a distributed node of a communication network based on a result of analyzing condition-related information relating to the conditions associated with the distributed node. The method also can comprise: based on the conditions and respective items of metadata associated with respective trained artificial intelligence (AI)-based models of a group of trained AI-based models associated with the distributed node, determining, by the system, whether to transition from having the distributed node utilize a first trained AI-based model to a second trained AI-based model to perform an operation of the distributed node, wherein the group of trained AI-based models comprises the first trained AI-based model and the second trained AI-based model.

In certain embodiments, the disclosed subject matter can comprise a system that can comprise at least one memory that can store computer executable components, and at least one processor that can execute computer executable components stored in the at least one memory. The computer executable components can comprise a data processor that can determine conditions associated with a distributed node of a communication network based on a result of an analysis of condition-related data relating to the conditions associated with the distributed node. The computer executable components also can comprise a model selector that, based on the conditions and respective items of metadata associated with respective trained AI-based models of a group of trained AI-based models associated with the distributed node, can determine whether to switch from having the distributed node utilize a first trained AI-based model to a second trained AI-based model to perform an operation of the distributed node, wherein the group of trained AI-based models can comprise the first trained AI-based model and the second trained AI-based model.

In still other embodiments, the disclosed subject matter can comprise a non-transitory machine-readable medium, comprising executable instructions that, when executed by at least one processor, can facilitate performance of operations. The operations can comprise determining conditions associated with a distributed node of a group of distributed nodes of a communication network based on a result of evaluating condition-related data relating to the conditions associated with the distributed node. The operations also can comprise: based on the conditions and respective metadata items associated with respective trained AI-based models of a group of trained AI-based models associated with the distributed node, determining whether to transition from having the distributed node utilize a first trained AI-based model to a second trained AI-based model to perform an operation of the distributed node, wherein the group of trained AI-based models can comprise the first trained AI-based model and the second trained AI-based model, and wherein the respective metadata items indicate which of the respective trained AI-based models is to be utilized under the conditions associated with the distributed node.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage and perform multi-node training and distributed node-specific training of artificial intelligence (AI)-based models, and selection of desirable node-specific trained AI-based models that can be utilized by distributed nodes, in accordance with various aspects and embodiments of the disclosed subject matter.

FIG. 2 depicts a block diagram of a non-limiting example system that can comprise a radio access network (RAN) that can comprise respective nodes that can facilitate desirably managing and performing multi-node training and distributed node-specific training of AI-based models and selecting desirable node-specific trained AI-based models that can be utilized by distributed nodes, in accordance with various aspects and embodiments of the disclosed subject matter.

FIG. 3 depicts a block diagram of a non-limiting example central node, comprising the central training node that can perform multi-node training of AI-based models and can perform model management functions to facilitate model selection by distributed nodes, in accordance with various aspects and embodiments of the disclosed subject matter.

FIG. 4 illustrates a block diagram of a non-limiting example system that can comprise a distributed node and a distributed training node that can perform node-specific training of multi-node trained AI-based models for particular use by the distributed node, wherein the distributed node can select a desirable node-specific trained AI-based model that can be utilized by distributed node for performance of AI-based operations, in accordance with various aspects and embodiments of the disclosed subject matter.

FIG. 5 illustrates a diagram of a non-limiting example data and process flow for data generation and model selection, in accordance with various aspects and embodiments of the disclosed subject matter.

FIG. 6 depicts a diagram of a non-limiting example AI component, in accordance with various aspects and embodiments of the disclosed subject matter.

FIG. 7 depicts a block diagram of non-limiting example system that can comprise the central node and the distributed training node(s) in the RAN in an open RAN (O-RAN) communication network environment to facilitate desirable management and performance of multi-stage training (e.g., multi-node and node-specific training) of AI-based models and selection of desirable node-specific trained AI-based models that can be utilized by distributed nodes, in accordance with various aspects and embodiments of the disclosed subject matter.

FIG. 8 depicts a diagram of a non-limiting example base station that can desirably facilitate connections and communication of information associated with devices, in accordance with various aspects and embodiments of the disclosed subject matter.

FIG. 9 illustrates a diagram of a non-limiting example device that can be operable to engage in a system architecture that facilitates wireless communications according to one or more embodiments described herein, in accordance with various aspects and embodiments of the disclosed subject matter.

FIG. 10 illustrates a flow chart of an example method that can desirably manage and perform selection of a desirable AI-based model from a group of AI-based models associated with a distributed node to perform desired AI-based operations on and for the distributed node, in accordance with various aspects and embodiments of the disclosed subject matter.

FIGS. 11-12 depict a flow chart of another example method that can desirably manage and perform selection of a desirable AI-based model from a group of AI-based models associated with a distributed node to perform desired AI-based operations on and for the distributed node, in accordance with various aspects and embodiments of the disclosed subject matter.

FIG. 13 illustrates an example block diagram of an example computing environment in which the various embodiments of the embodiments described herein can be implemented.

FIG. 14 depicts a diagram of non-limiting example time series data of respective distributed nodes.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that can manage and perform multi-node and node-specific artificial intelligence (AI)-based model training associated with a radio access network (RAN) of a communication network. Communication networks can enable users to use devices to wirelessly connect to a communication network and communicate with other devices (e.g., wireless devices or other communication devices). Communication networks also may employ AI-based technology to perform various tasks. For example, a communication network can employ an AI-based model to generate an inference or perform a task that can relate to operation of the communication network.

In some communication networks, there can be one or more RANs that each can comprise a group of distributed nodes that can perform various network-related functions. As an example, a distributed node can be a radio unit (RU) of a RAN (e.g., a disaggregated RAN). Existing techniques often can collect data relating to the distributed nodes and process such data centrally in the communication network.

For various types of applications, it can be desirable to utilize a model (e.g., an AI or machine learning (ML) model) for inference and other desired purposes at the network edge of the communication network (or in other parts of the communication network). However, existing techniques can be deficient (e.g., inefficient, inaccurate, unsuitable, poor performing, suboptimal, or otherwise undesirable) in training AI or ML models and/or utilizing AI or ML models at the network edge of the communication network, and, accordingly, such AI or ML models can be deficient for use at the network edge of the communication network.

With further regard to the data associated with the distributed nodes, in networks with distributed nodes, while a relatively wide range of performance outcomes can be possible, each distributed node can be operating under different environmental and operational conditions. These conditions can determine a subset of overall potential performance outcomes at each node. Due to environmental and usage impacts, the behavior of components can evolve over time differently between different distributed nodes. Thus, data generated on each distributed node can, in some scenarios, differ from the data generated on other distributed nodes in the deployment. Accordingly, the data generated at each distributed node typically can differ between respective distributed nodes due in part to differences in data traffic load of the respective distributed nodes, differences in environmental conditions associated with respective distributed nodes, differences in configurations (e.g., node-specific hardware and/or software configurations) between the respective distributed nodes, and/or for other reasons. Different operational or environmental conditions can mean that it can be desirable to employ different optimization strategies. These different optimization strategies can be represented in distinct AI-based models. Data or datasets generated from each unique distributed node (e.g., each uniquely optimized distributed node) can exhibit statistically different characteristics from one another. Time series data generated by distributed nodes can be represented by a statistically unique segment of the data or dataset.

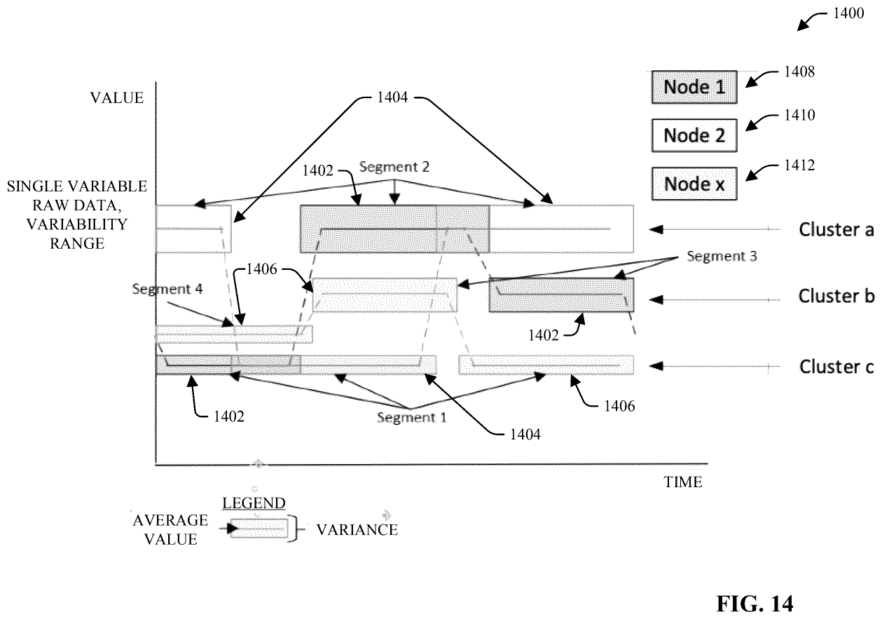

With further regard to time series data, the respective data collected from the respective distributed nodes can be time series data, wherein the time series data collected (e.g., centrally collected by the communication network) from each distributed node typically can be a succession of segments and can be based on respective (e.g., independent or unique) conditions experienced by each distributed node of a deployment. These data segments can be the same for all or a subset of distributed nodes, can have similar properties or characteristics, or can result from significantly different operational scenarios. As a result, the distributed nodes can be said to have data variability, such as can be illustrated in FIG. 14. FIG. 14 is a diagram of a non-limiting example time series data 1400 of respective distributed nodes, where there can be statistical characteristics of single-dimensional, single variable time series data with multiple data segments (although not limited to single-dimensional, single variable time series data). With regard to the data segments depicted in the time series data 1400, each of the time series data (e.g., time series data 1402, time series data 1404, and time series data 1406) can be generated in a different distributed node (e.g., node 1 1408, node 2 1410, and node x 1412, respectively). While for example purposes the time series data 1400 can be single dimensional and/or single variable time series data, time series data associated with distributed nodes also can be multi-dimensional and/or multi-variable time series data.

Collecting distributed data associated with the distributed nodes, bulk aggregating that data into a dataset, and creating a single AI or ML model for use in all distributed nodes, without accounting for the unique characteristics of each distributed node or specific segment, can lead to suboptimal performance of the model due to a deficient one-size-fits-all approach. Also, always using the same AI or ML model variant for each time series data and each distributed node can result in lower performance of the model due to the significant differences between data collected from different distributed nodes. It is noted that there may be instances where similar data segments can be present in data generated by different distributed nodes, where the same AI or ML model can be applicable though.

Further, it can be desirable to utilize AI-based models for inference execution and/or other AI-based analysis and output. In order to do so, it can be desirable to have AI-based models in each distributed node that can be suitable with respect to the locally observed conditions associated with that distributed node. To enable desirable (e.g., useful, enhanced, or optimal) use cases based on AI-based models with low latency specifications (e.g., requirements), the inference execution or other AI-based analysis potentially may be performed locally at the distributed nodes. However, due to practical product design of distributed nodes, the resources available at a distributed node for inference processing or other AI-based analysis can be undesirably limited. Therefore, it can be desirable for AI-based models to be sufficiently (e.g., highly) optimized in terms of resource usage. Such an approach can be said to be efficient where the AI-based models can be proportionally smaller with lower latency than a generic model applicable at all distributed nodes (e.g., where such an AI-based model can overcome the one-size-fits-all model inefficiencies). Unfortunately, existing systems, methods, and techniques for generating AI-based models can be deficient in generating AI-based models that can be desirable for the particularized use at a particular distributed node.

It can be desirable to address and overcome the aforementioned deficiencies and other deficiencies of existing systems and techniques for training and using AI or ML models, and for selecting AI or ML models. In that regard, the disclosed subject matter can provide enhanced techniques that can desirably (e.g., suitably, beneficially, advantageously, usefully, enhancedly, or optimally) address and overcome the aforementioned deficiencies and other deficiencies of the existing systems and techniques.

To that end, techniques that can desirably (e.g., automatically, dynamically, suitably, reliably, efficiently, enhancedly, and/or optimally) manage and perform multi-node training and node-specific training of AI-based models for use by distributed nodes, and selection of desirable node-specific trained AI-based models that can be utilized by distributed nodes, are presented. A system can comprise a communication network that can comprise a central node and one or more groups of distributed nodes that can be associated with the central node. In accordance with various embodiments, the communication network can comprise one or more RANs (e.g., a disaggregated RAN(s)), wherein the central node can be part of or associated with a central unit (CU) of a RAN or a core network associated with (e.g., communicatively connected to) the RAN and part of the communication network. In accordance with various embodiments, respective distributed nodes can be, or can be part of or associated with, respective radio units (RUs) or respective distributed units (DUs) of the RAN, for each of the one or more RANs. The respective distributed nodes also can comprise or can be associated with respective distributed training nodes that can be, or can be part of or associated with, the respective RUs or the respective DUs of the RAN, for each of the one or more RANs.

In some embodiments, with regard to the central node, the central node can comprise a central training node that, in response to a model training request from a model manager node, can train (e.g., can perform first stage, multi-node training of) an AI-based model, based at least in part on first training data (e.g., joint or multi-node training data) and a first group of parameters and/or hyperparameters, to generate a trained AI-based model relating to the group of distributed nodes such that the trained AI-based model can satisfy a first threshold performance level, wherein the first training data can be derived from information relating to respective conditions and/or respective characteristics associated with and collected from respective distributed nodes of the group of distributed nodes. The respective conditions can relate to, for example, respective operational conditions associated with the respective distributed nodes, respective communication-related conditions associated with the respective distributed nodes, respective data traffic and processing load-related conditions associated with the respective distributed nodes, respective environmental conditions relating respective environment associated with the respective distributed nodes, and/or other conditions associated with the respective distributed nodes or other network equipment or devices associated therewith. In some embodiments, the trained AI-based model can be stored in a model repository of the central node.

In certain embodiments, in connection with a model training request, received from the model manager node, to perform second stage, node-specific training of the trained AI-based model, the distributed training node associated with the distributed node can receive the trained AI-based model from the model repository of the central node. In some embodiments, as part of or in connection the model training request, the distributed training node also can receive second training data (e.g., node-specific training data) and a second group of parameters and/or hyperparameters, wherein the second training data can be derived from information relating to respective conditions and/or respective characteristics associated with, particular or unique to, and collected from the distributed node. In certain embodiments, the distributed training node can train (e.g., can perform second stage, node-specific training of) the trained (e.g., multi-node trained) AI-based model, based at least in part on the second training data and the second group of parameters and/or hyperparameters, to generate a refined (e.g., adapted or customized) trained AI-based model relating to the particular conditions and characteristics associated with the distributed node such that the refined trained AI-based model can satisfy a second threshold performance level that can be higher than the first threshold performance level, particularly with regard to generation of AI-based output result data (e.g., inferences probabilities, and/or other AI-based output result data) for the distributed node, and such that the refined trained AI-based model can be tailored (e.g., customized or adapted) to account for the conditions and characteristics associated with the distributed node in connection with the refined trained AI-based model generating AI-based output result data. The refined trained AI-based model can be utilized by the distributed node (e.g., when the conditions and/or characteristics associated with the distributed node make the use of the refined trained AI-based model desirable) and/or can be stored in a local model library in a data store of the distributed node and/or can be stored in the model repository of the central node (e.g., for availability and use by the distributed node when desirable).

Similarly, other respective distributed training nodes associated with other respective distributed nodes can train the trained AI-based model (or another multi-node trained AI-based model), based at least in part on respective training data and respective groups of parameters and/or hyperparameters, to generate other respective refined trained AI-based models for use by the other respective distributed nodes. The other respective refined trained AI-based models also can be stored in respective local model libraries (e.g., local model repositories) of the other respective distributed nodes and/or can be stored in the model repository of the central node (e.g., for availability and use by the other distributed nodes when desirable).

In accordance with various embodiments, with regard to a distributed node of the group of distributed nodes, the distributed node can comprise a data collector component that can monitor operations and conditions, and can obtain or collect conditions-related information relating to the conditions, associated with the distributed node, a data processor component that can analyze and process data, including the condition-related information, and a model selector component that can determine and select a desirable refined trained AI-based model, from a group of refined trained AI-based models associated with the distributed node, for use by the distributed node. In some embodiments, respective refined trained AI-based models of the model group can be stored in a local model repository of the distributed node and/or the model repository of the central node. In an example scenario, the distributed node can be utilizing a first refined trained AI-based model of the model group to perform desired operations (e.g., performing desired AI-based operations to generate inferences, probabilities, and/or other AI-based output result data) of the distributed node. In certain embodiments, the data processor component can determine conditions associated with the distributed node based at least in part on analyzing condition-related information relating to the conditions associated with distributed node.

Based at least in part on the conditions, the model selector component can determine whether a threshold amount of change in the conditions associated with the distributed node has occurred (e.g., is detected). If it is determined that the threshold amount of change in the conditions has not occurred or is not detected, the model selector component can determine whether there is a configuration update that relates to the first trained AI-based model (e.g., can determine whether the first trained AI-based model is to have a configuration update performed). If the model selector component determines that there is no configuration update, the model selector component can determine that there is to be no transition from having the distributed node utilize the first refined trained AI-based model to the second refined trained AI-based model at this time. The data collector component can continue to monitor conditions associated with the distributed node.

In some embodiments, if the model selector component determines that there is configuration update for the first refined trained AI-based model, or determines that the threshold amount of change in the conditions has occurred (or correspondingly, determines a threshold amount of change in performance of the distributed node has occurred indicated undesirable or degraded distributed node performance), the model selector component can determine whether to transition from having the distributed node utilize the first refined trained AI-based model to utilizing a second first refined trained AI-based model of the model group to perform operations of the distributed node. In certain embodiments, statistical data relating to a group of condition-related information items relating to respective conditions associated with one or more respective distributed nodes, comprising the distributed node, can be determined (e.g., by the data processor component of the distributed node and/or a data processor component of the central node). In some embodiments, based at least in part on the results of analyzing the conditions, the statistical data, respective metadata items associated with the respective refined trained AI-based models of the model group, comprising the first refined trained AI-based model and a second refined trained AI-based model, performance information relating to model and/or distributed node performance, and defined model selection criteria, the model selector component can determine which of the respective refined trained AI-based models of the model group can be selected to perform the operation of the distributed node. The conditions, or at least some of the conditions, can be or can relate to independent input variables and/or dependent input variables that can be input to the refined trained AI-based models. The respective metadata items can indicate which of the respective first refined trained AI-based model is to be utilized under respective conditions associated with the distributed node. In some embodiments, the respective metadata items can provide information regarding the origins of the data (e.g., information regarding which of the distributed nodes were part of the training dataset utilized for model training and/or other desired information). In certain embodiments, the respective metadata items also can comprise artifacts that can indicate or relate to one or more desired performance goals (e.g., performance enhancement goals) for performance of the distributed node and/or model. The defined model selection criteria, which can comprise defined distributed node performance criteria (e.g., distributed node enhanced or optimized performance criteria), can indicate or relate to one or more desired performance goals (e.g., performance enhancement goals) for performance of the distributed node, model, or network, can indicate or specify a threshold amount of change (e.g., threshold amount of change in conditions or performance) that can trigger a model selection/reselection evaluation and/or determination, and/or can indicate or relate to other criteria that can be utilized (e.g., applied) to facilitate determining which of the respective refined trained AI-based models of the model group can be the desirable refined trained AI-based model to select for use in performing inference and other AI-based operations for the distributed node.

If, based at least in part on the results of such analysis, the model selector component determines that the first refined trained AI-based model can be the most desirable (e.g., most suitable, enhanced, or optimal) model of the model group, the model selector component can determine that the first refined trained AI-based model can continue to be utilized by the distributed node to perform the desired operations of the distributed node. In certain embodiments, the model selector can initiate a timer for a defined time period to enable additional condition-related information relating to the conditions associated with the distributed node to be obtained by the data collector component, and the data collector component can continue to monitor conditions associated with the distributed node. If, instead, based at least in part on the results of such analysis, the model selector component determines that the second first refined trained AI-based model can be the most desirable (e.g., most suitable, enhanced, or optimal) model of the model group, the model selector component can control (e.g., manage) the transitioning from having the distributed node utilize the first refined trained AI-based model to utilizing the second first refined trained AI-based model to perform the desired operations of the distributed node.

These and other aspects and embodiments of the disclosed subject matter will now be described with respect to the drawings.

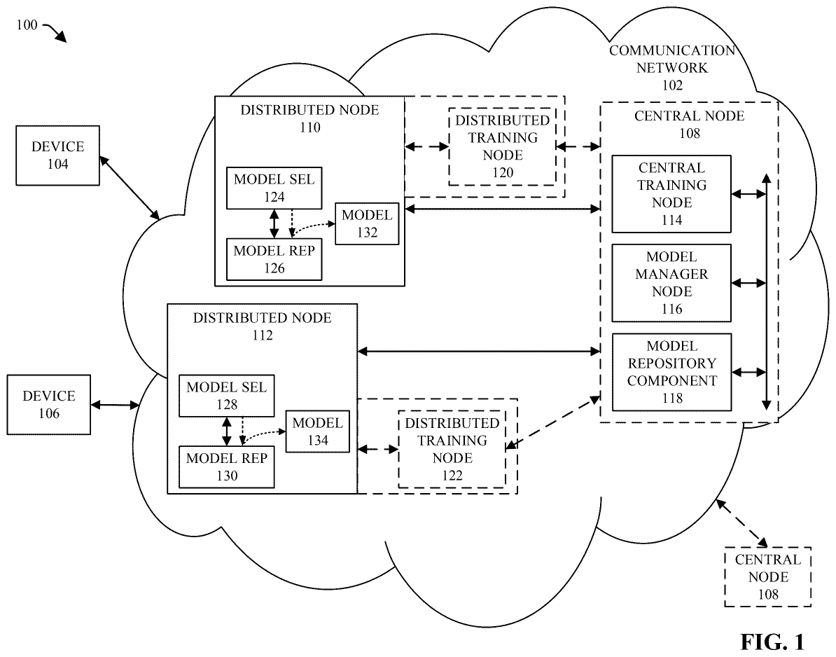

Referring now to the drawings, FIG. 1 illustrates a block diagram of a non-limiting example system 100 that can desirably (e.g., automatically, dynamically, suitably, reliably, efficiently, enhancedly, and/or optimally) manage and perform multi-node training and distributed node-specific training of AI-based models, and selection of desirable node-specific trained AI-based models that can be utilized by distributed nodes, in accordance with various aspects and embodiments of the disclosed subject matter. The system 100 can comprise a communication network 102 that can enable wireless and wireline communication of information between devices, such as device 104 and device 106, associated with (e.g., communicatively connected to) the communication network 102, and/or between the device (e.g., device 104) and the communication network 102. In some embodiments, the communication network 102 can comprise a core network and one or more RANs, associated with the core network, that can enable the wireless communication of information between the device (e.g., device 104) and the RAN and core network, such as described herein.

In certain embodiments, the communication network 102 can comprise a central node 108 and a group (e.g., cluster) of distributed nodes, which can comprise one or more distributed nodes, such as distributed node 110 and/or distributed node 112, that can be associated with (e.g., communicatively connected to) the central node 108. In some embodiments, the communication network 102 also may comprise one or more other groups of distributed nodes that can be associated with (e.g., communicatively connected to) the central node 108. In accordance with various embodiments, all or a portion of the central node 108 can be part of the core network and/or the RAN (e.g., the CU or other component of the RAN), such as described herein. In certain other embodiments, all or part of the central node 108 also may be located outside of the communication network 102 and communicatively connected to the communication network 102, and can be part of the AI/ML infrastructure that can serve the communication network 102. In accordance with various embodiments, all or a portion of the distributed node 110 can be part of an RU or a DU of the RAN, and/or all or a portion of the distributed node 112 can be part of an RU or a DU of the RAN, such as described herein. In some embodiments, all or some of the respective distributed nodes (e.g., 110 and 112) of the group of distributed nodes can be located (e.g., physically and/or logically located) at or near an edge (e.g., network edge) of the communication network 102 (e.g., in relatively and significantly closer proximity to one or more of the devices (e.g., 104 and/or 106) than the central node 108 and core network). It is to be appreciated and understood that, while various aspects and embodiments described herein can relate to cellular and wireless networks and communications, in certain embodiments, the communication network 102 can be a communication network other than a cellular and/or wireless network, and the central node 108, the distributed nodes (e.g., 110 and/or 112), and/or other components of the system 100 can be employed in such communication network 102.

In accordance with various embodiments, the central node 108 can comprise a central training node 114, a model manager node 116, and a model repository 118. In certain embodiments, the central training node 114, the model manager node 116, and the model repository 118 can be in the same central node 108. In certain other embodiments, the central training node 114, the model manager node 116, and/or the model repository 118 can be in separate central nodes that can be communicatively connected to each other, or can be part of separate portions of the central node 108, wherein the separate portions of the central node 108 can be communicatively connected to each other. In some embodiments, the central training node 114 (e.g., in conjunction with the model manager node 116) can perform multi-node training of a model (e.g., AI-based model), based at least in part on first training data (e.g., joint or multi-node training data), to generate a trained model relating to the group of distributed nodes (e.g., 110 and 112), wherein the first training data can be derived from information relating to respective conditions and/or respective characteristics associated with the respective distributed nodes (e.g., 110, 112) that can be received or collected (e.g., by the central node 108) from the respective distributed nodes (e.g., 110, 112) and/or other data sources. For instance, as part of a first stage of multi-stage model training, the central training node 114 can train (e.g., iteratively train) the model, based at least in part on the first training data, to generate the trained model (e.g., trained AI-based model) relating to conditions and/or characteristics associated with the group of distributed nodes (e.g., 110 and 112) such that the trained model can have a first performance level that can satisfy a first threshold performance level relating to generating AI-based output result data (e.g., inferences, probabilities, and/or other AI-based output result data), such as described herein. In certain embodiments, the central training node 114 can store the trained model in the model repository 118 (e.g., model catalog of the model repository 118 in a data store).

In accordance with various embodiments, the group of distributed nodes can comprise or can be associated with (e.g., communicatively connected to) a group of distributed training nodes that can train (e.g., further train, refine or adapt training of, and/or perform node-specific training of) trained models to generate refined trained models (e.g., refined trained AI-based models) that can be node-specific or particularized for the respective distributed nodes of the group of distributed nodes. In some embodiments, the group of distributed training nodes can comprise distributed training node 120 that can be part of, co-located with (e.g., physically co-located with), or associated with the distributed node 110, distributed training node 122 that can be part of, co-located with, or associated with the distributed node 112, and/or another distributed training node that can be part of, co-located with, or associated with another distributed node. In certain embodiments, one or more distributed training nodes can be instantiated for use in the system 100, as desired. In some embodiments, a distributed training node (e.g., 120 or 122) can share the same hardware and/or software resources with the associated distributed node (e.g., 110 or 112), and, in other embodiments, a distributed training node can alternatively or additionally comprise its owns hardware and/or software resources.

In some embodiments, the distributed node 110, the distributed training node 120, the distributed node 112, and the distributed training node 122 can be located at or near the network edge of communication network 102 (e.g., in relatively closer proximity to the respective devices (e.g., device 104 and/or device 106) than the central node 108 and the core network), whereas the central node 108 can be more centrally located in the communication network 102 and relatively further away from the network edge. In certain embodiments, the respective refined trained models generated by the respective distributed training nodes (e.g., 120 and/or 122) also can be located at or near the network edge, and can be utilized by the respective distributed nodes (e.g., 110 and/or 112) at or near the network edge to desirably (e.g., suitably, efficiently, reliably, enhancedly, and/or optimally) perform AI-based analysis and provide AI-based output result data that can be utilized by the respective distributed nodes to perform various services, functions, and/or operations.

In certain embodiments, as part of a second stage of the multi-stage model training, the distributed training node 120 can train (e.g., iteratively train) the trained model, based at least in part on second training data (e.g., node-specific training data), to generate a refined (e.g., adapted) trained model relating to conditions and/or characteristics (e.g., particularized or unique conditions and/or characteristics) associated with the distributed node 110 such that the refined trained model can have a second performance level that can satisfy a second threshold performance level relating to generating AI-based output result data, and such that the refined trained model can be tailored (e.g., customized or adapted) to account for the conditions and characteristics associated with the distributed node 110 in connection with the refined trained model generating AI-based output result data, wherein the second threshold performance level can be higher than the first threshold performance level, and wherein the second performance level of the refined trained model can be higher than the first performance level of the trained model (e.g., multi-node trained model), such as described herein. The second training data can be derived or determined (e.g., by the central node 108, or, in other embodiments, by the distributed node 110 or the distributed training node 120) from information relating to the conditions and/or characteristics associated with the distributed node 110 that can be generated or collected by the distributed node 110 and/or obtained from other data sources. In certain embodiments, the refined trained model (e.g., performing at the higher second performance level) can provide enhanced (e.g., improved, optimized, or increased accuracy of) AI-based output data results with regard to the distributed node 110, as compared to other AI-based output data results that the trained model (e.g., performing at the lower first performance level) would be able to provide with regard to the distributed node 110.

In some embodiments, similarly, the distributed training node 122 can train the trained model, based at least in part on third training data, to generate a refined (e.g., adapted) trained model relating to conditions and/or characteristics associated with the distributed node 112 such that the refined trained model can have a second performance level that can satisfy the second threshold performance level.

In accordance with various embodiments, the respective distributed nodes of the group of distributed nodes can comprise respective model selector components and respective model repositories, wherein a model repository of a distributed node also can be referred to herein as a local model repository). For instance, the distributed node 110 can comprise a model selector component (MODEL SEL) 124 and a model repository (MODEL REP) 126 (also referred to herein as a local model repository 126), and/or the distributed node 112 can comprise a model selector component 128 and a model repository 130 (also referred to herein as a local model repository 130). In some embodiments, the distributed training node 120 can communicate the refined trained AI-based models generated by the distributed training node 120 and/or associated information (e.g., metadata) to the distributed node 110 for storage in the model repository 126 and/or to the central node 108 for storage in the model repository 118. Similarly, the distributed training node 122 can communicate the refined trained AI-based models generated by the distributed training node 122 and/or associated information (e.g., metadata) to the distributed node 112 for storage in the model repository 130 and/or to the central node 108 for storage in the model repository 118.

The respective distributed nodes (e.g., 110 and/or 112), employing their respective model selector components (e.g., 124 and/or 128), can determine and select respective desirable refined trained AI-based models (e.g., model 132 and model 134, respectively) from their respective local model repositories (e.g., 126 and/or 130) or the model repository of the central node 108 for use in performing inference operations and/or other desired AI-based operations, in accordance with the defined model management criteria (e.g., defined model selection criteria of the defined model management criteria). For instance, the distributed node 110 can monitor and determine conditions associated with the distributed node 110, such as described herein. Based at least in part on the conditions associated with the distributed node 110, respective items of metadata (e.g., which can indicate respective characteristics) associated with respective refined trained AI-based models of a group of refined trained AI-based models associated with the distributed node 110, and/or other information (e.g., statistical data, model validation and/or feedback information relating to model and/or distributed node performance, configuration update information, and/or other information, such as described herein), the model selector component 124 can determine whether there is to be a transition from the distributed node 110 utilizing a first (e.g., current) AI-based model of the model group to utilizing a second AI-based model of the group to perform AI-based operations for the distributed node 110, and, if there is to be such transition, the model selector component 124 can perform such transition to a desirable (e.g., most suitable, enhanced, or optimal) refined trained AI-based model of the model group (e.g., the second AI-based model), in accordance with the defined model selection criteria, such as described herein. The model selector component 124 can retrieve the desirable refined trained AI-based model from the local model repository 126 or the model repository 118 of the central node 108, and the distributed node 110 can utilize the desirable refined trained AI-based model (e.g., model 132) to perform various desired AI-based operations (e.g., inference and/or other AI-based operations). These and other aspects and embodiments of the disclosed subject matter will now be described with respect to this drawing and the other drawings.

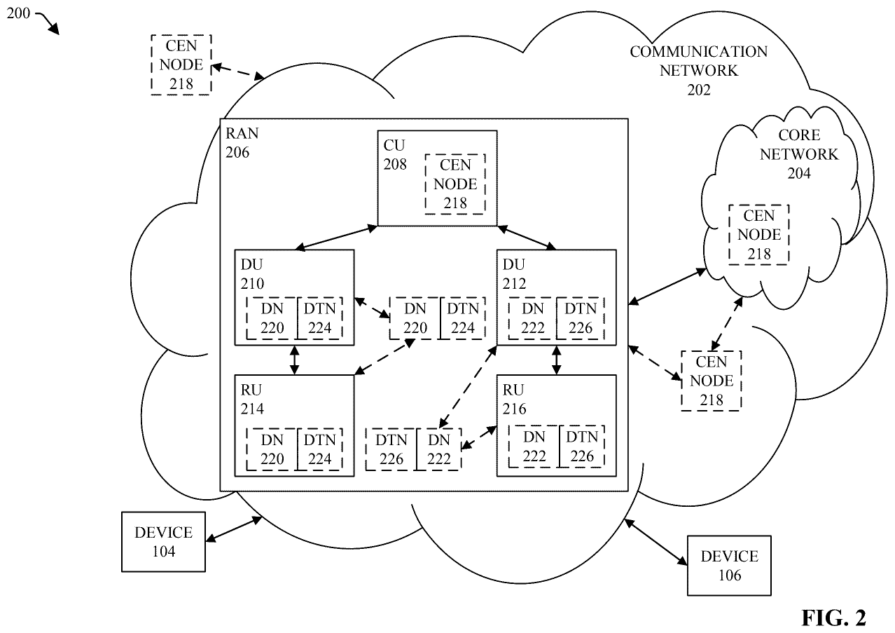

Referring to FIG. 2 (along with FIG. 1), FIG. 2 depicts a block diagram of a non-limiting example system 200 that can comprise a RAN (e.g., a disaggregated RAN) that can comprise respective nodes that can facilitate desirably (e.g., automatically, dynamically, suitably, reliably, efficiently, enhancedly, and/or optimally) managing and performing multi-node training and distributed node-specific training of AI-based models and selecting desirable node-specific trained AI-based models that can be utilized by distributed nodes, in accordance with various aspects and embodiments of the disclosed subject matter. The system 200 can comprise a communication network 202 that can comprise a core network 204 and one or more RANs, such as RAN 206, that can be associated with (e.g., communicatively connected to) the core network 204. Each RAN (e.g., RAN 206) can comprise one or more base stations that each can comprise one or more cells (not shown in FIG. 2).

The core network 204, the one or more RANs (e.g., RAN 206), the one or more base stations, and the one or more cells can facilitate (e.g., enable) wireless communication of data (e.g., voice or other audio data, video data, textual data, or other data) between devices (e.g., communication devices or UEs), such as devices associated with the core network 204, via the one or more RANs, one or more base stations, and one or more cells, and other devices associated with the core network 204 or, more generally, the communication network 202 (e.g., a device, such as a server or computer, can be connected to the communication network 202 via a wireline connection or via a network other than the core network 204).

The devices can comprise, for example, devices 104 and/or 106. A device (e.g., 104 or 106) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term UE can be used to describe the device. The device (e.g., 104 or 106) can be associated with (e.g., communicatively connected to) the communication network 202 via a communication connection and channel, which can include a wireless or wireline communication connection and channel.

In accordance with various embodiments, the core network 204 can comprise various network components that can facilitate wireless communication of data. In some embodiments, the RAN 206 can be a 5G or other RAN (e.g., gNB or xG RAN, wherein x can be a number greater than 5), and/or the base station(s) can be a 5G or other base station (e.g., gNB or xG base station, wherein x can be a number greater than 5). In some embodiments, the RAN 206 can be an open RAN (O-RAN) that can be part of an O-RAN architecture and environment (e.g., the communication network 202 can employ an O-RAN architecture and environment), such as described herein. In certain embodiments, the core network 204 can comprise a user plane function (UPF) (also can be referred to as a UPF node), an application function (AF) (also can be referred to as an AF node), an application server, an access and mobility management function (AMF), and/or other network functions (not shown in FIG. 2 for reasons of brevity and clarity). The UPF can connect to or interface with the one or more RANs (e.g., RAN 206) and the one or more base stations, can be an interconnect point between the core network 204 and a data network, can provide or facilitate providing a protocol data unit (PDU) session anchor point for providing mobility associated with radio access technologies (RATs), can provide or facilitate providing data packet routing or forwarding, and/or can perform or manage other functions.

The AF, which can be a control plane function, can be associated with, and can act as or fulfill all or part of the role of, the application server, and can interact and communicate with other network functions, including control plane functions, of the core network 204. The AF and associated application server can facilitate (e.g., enable) provision of various services (e.g., voice services, messaging services, media streaming services, Internet and intranet services, multimedia conferencing and collaboration services, or other services) and applications to devices associated with the core network 204. In some embodiments, some of the services can be low latency services and/or network edge services. The AF can comprise one or more AFs that respectively can be owned or managed by the network operator of the core network 204 or by third parties (e.g., trusted third parties). In some embodiments, the UPF can be associated with, and can interact and communicate with, the AF and/or other network functions (e.g., other control plane functions) via a service-based interface (SBI).

The AMF node can be a control plane function that can manage registration and deregistration of devices (e.g., devices 104 and/or 106) with the core network 204, manage connections of devices with the core network 204, manage mobility associated with devices (e.g., maintain knowledge of locations of devices, update locations of devices), and/or manage or perform other functions. In accordance with various other embodiments, the RAN(s) (e.g., RAN 206) and/or the base station(s) can comprise both 4^{th} generation (4G) long term evolution (LTE) technology and functions, and 5G or xG technology and functions.

The communication network 202, more generally, or the core network 204 can comprise various other network equipment (e.g., routers, gateways, transceivers, switches, access points, network functions, processor components, data stores, or other devices or network nodes) that facilitate (e.g., enable) communication of information between respective items of network equipment of the communication network 202, and/or communication of information between the one or more devices (e.g., devices 104 and/or 106) and the communication network 202. The communication network 202, including the core network 204, can provide or facilitate wireless or wireline communication connections and channels between the one or more devices (e.g., devices 104 and/or 106), and/or respectively associated services or applications, and the communication network 202. For reasons of brevity or clarity, some of the various network equipment, components, functions, or devices of the communication network may not be explicitly shown or described herein.

At various times, the respective devices (e.g., devices 104 and/or 106) can utilize respective services or applications. The services or applications can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

In some embodiments, the RAN 206 can be a disaggregated RAN that can comprise a CU 208, one or more DUs, such as DU 210 and/or DU 212, and one or more RUs, such as RU 214 and/or RU 216. The CU 208 can be associated with the one or more DUs (e.g., 210 and/or 212), and the one or more respective DUs can be associated with the one or more respective RUs (e.g., 214 and/or 216). In certain embodiments, the DU (e.g., 210 or 212) can be located in a first location (e.g., geographical, physical, and/or logical location), the CU 208 can be located in the first location or a second location, and the RU (e.g., 214 or 216) can be located in the first location, the second location, or a third location.

In accordance with various embodiments, all or respective portions of a central node (CEN NODE) 218 can be part of the core network 204, the CU 208, and/or another component (e.g., service management and orchestration (SMO) or RAN Intelligent Controller (RIC)) of the communication network 202 (e.g., the core network 204 can be or can comprise all or a portion of the central node 218, and/or the CU 208 can be or can comprise all or a portion of the central node 218), or the central node 218 can be a standalone component that can be associated with (e.g., communicatively connected to) the core network 204 and/or the CU 208. In accordance with various embodiments, all or respective portions of a distributed node (DN) 220 can be part of the RU 214, the DU 210, and/or another component of the communication network 202 (e.g., the RU 214 can be or can comprise all or a portion of the distributed node 220, and/or the DU 210 can be or can comprise all or a portion of the distributed node 220), or the distributed node 220 can be a standalone component that can be associated with the RU 214, the DU 210, the central node 218, and/or another component of the communication network 202. Similarly, in accordance with various embodiments, all or respective portions of a distributed node 222 can be part of the RU 216, the DU 212, and/or another component of the communication network 202 (e.g., the RU 216 can be or can comprise all or a portion of the distributed node 222, and/or the DU 212 can be or can comprise all or a portion of the distributed node 222), or the distributed node 222 can be a standalone component that can be associated with the RU 216, the DU 212, the central node 218, and/or another component of the communication network 202.

In accordance with various embodiments, all or respective portions of a distributed training node (DTN) 224 can be part of the distributed node 220, and/or the distributed training node 224 can be associated with (e.g., communicatively connected to) the distributed node 220. Similarly, in accordance with various embodiments, all or respective portions of a distributed training node 226 can be part of the distributed node 222, and/or the distributed training node 226 can be associated with (e.g., communicatively connected to) the distributed node 222.

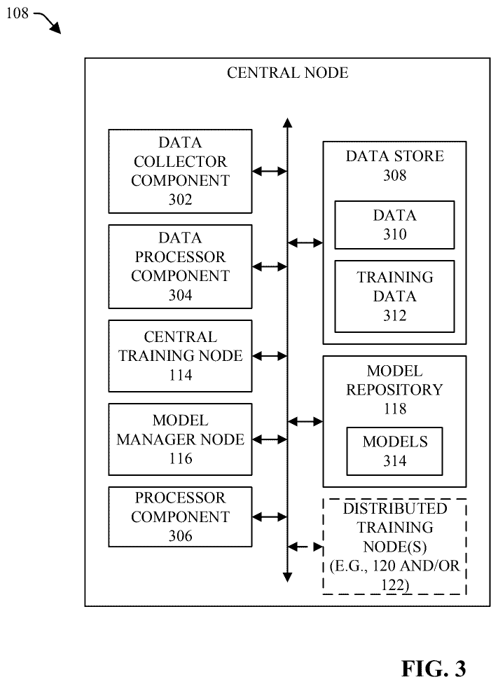

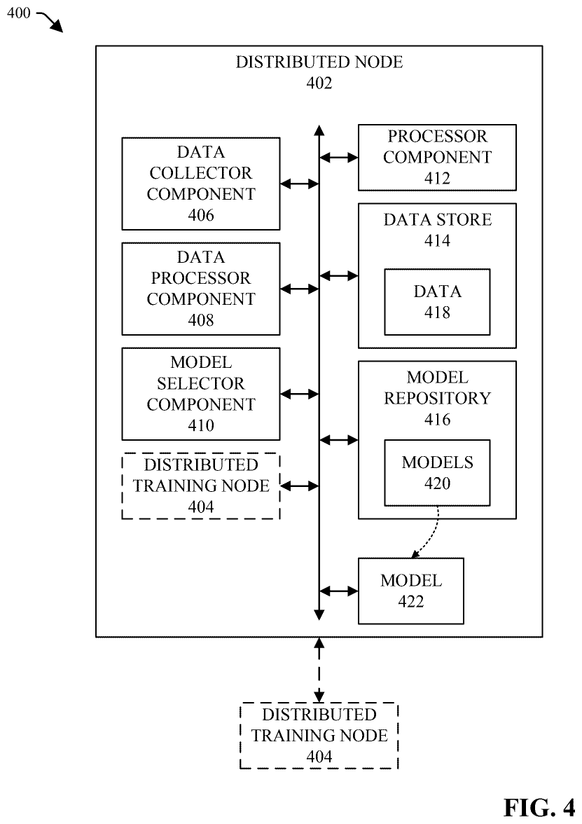

Referring to FIGS. 3 and 4 (along with FIGS. 1 and 2), FIG. 3 is a block diagram of a non-limiting example central node 108, comprising the central training node 114 that can perform multi-node training of AI-based models and can perform model management functions to facilitate model selection by distributed nodes, and FIG. 4 is a block diagram of a non-limiting example system 400, which can comprise a distributed node 402 and a distributed training node 404 that can perform node-specific training of multi-node trained AI-based models for particular use by the distributed node 402, wherein the distributed node 402 can select a desirable node-specific trained AI-based model that can be utilized by distributed node 402 for performance of AI-based operations, in accordance with various aspects and embodiments of the disclosed subject matter. In accordance with various embodiments, the central node 108 can comprise a data collector component 302, a data processor component 304, the central training node 114, the model manager node 116, a processor component 306, and a data store 308. In some embodiments, the data store 308 can store various types of data relating to the central node 108, distributed nodes (e.g., distributed node 110 (or 402), distributed node 112), distributed training nodes (e.g., distributed training node 120 (or 404), distributed training node 122), devices (e.g., device 104, device 106), the core network 204, and/or the communication network 102. The various types of data stored in the data store 308 can comprise, for example, data 310, such as collected data (e.g., distributed node-related data relating to respective conditions and/or respective characteristics associated with respective distributed nodes), statistical data (e.g., statistical data that can be derived from and/or representative of the distributed node-related data associated with the distributed nodes), other processed or derived data, metadata (e.g., parameters, hyperparameters, and/or other metadata), and/or other type(s) of data, training data 312 that can be utilized for training (e.g., multi-node training) of AI-based models to generate trained AI-based models 314 (e.g., multi-node trained AI-based models and node-specific refined trained AI-based models), which can be stored in the model repository 118 of the central node 108 along with model-related information (e.g., respective parameters, respective hyperparameters, and/or other respective metadata associated with the respective trained AI-based models 314). In accordance with various embodiments, some of the metadata can comprise descriptor information that can describe or identify respective characteristics of a trained (e.g., multi-node trained) AI-based model and/or a refined trained AI-based model to facilitate distributed node-specific training of the trained AI-based model to generate the refined trained AI-based model, model selection to facilitate determining (e.g., by the model selector component) whether to select the refined trained AI-based model for use by the distributed node (e.g., distributed node 110 (or 402)), inference or other AI-based operations by the reference trained AI-based model, and/or performance of other functions and/or operations, such as described herein. In some embodiments, the respective characteristics can relate to respective attributes of respective training datasets that were utilized to train the respective refined trained AI-based models, wherein such attributes of the respective training datasets can be preserved and utilized (e.g., by the model manager component 116) to improve model selection by the model selector component at the distributed node (e.g., 110 (or 402)). In certain embodiments, the respective metadata also can comprise or relate to certain respective artifacts (e.g., respective goal-related information) that can indicate one or more respective performance goals (e.g., performance enhancement goals that can comprise, a model performance goal(s), a distributed node performance goal(s), and/or a network level performance goal(s)) associated with the model selection.

The AI-based models stored in the model repository 118 can comprise the trained AI-based models (e.g., multi-node trained AI-based models) and/or refined (e.g., adapted) trained AI-based models (e.g., refined node-specific trained AI-based models), wherein the central node 108 can receive the refined trained AI-based models from the respective distributed training nodes (e.g., 120 (or 404), 122) for storage in the model repository 118. In some embodiments, the model repository 118 (e.g., a data store utilized as the model repository) can comprise nonvolatile memory and/or volatile memory usable for storage of data, such as described herein.

In certain embodiments, the distributed node 402 can be one distributed node of a group of distributed nodes that can be associated with the central node 108 in the communication network 102. For instance, the distributed node 402 can be the same as or similar to the distributed node 110 or distributed node 112, as depicted in FIG. 1. For clarity and brevity, only one distributed node 402 and one distributed training node 404 are illustrated in FIG. 4, and it is to be appreciated and understood that the group of distributed nodes can comprise virtually any desired number (e.g., 1, 2, 3, 4, 5, or other desired number greater than 5) of distributed nodes that can be associated with (e.g., communicatively connected to) the central node 108, and correspondingly, the respective distributed nodes of the group of distributed nodes can be associated with respective distributed training nodes, which also can be associated with the central node 108. In accordance with various embodiments, the distributed node 402 can comprise, for example, a data collector component 406, a data processor component 408 (e.g., a data processor that can analyze, filter, select, and/or otherwise process data), a model selector component 410, a processor component 412, a data store 414, and/or a model repository 416 (which also can be referred to as a local model repository of the distributed node 402). In some embodiments, the data store 414 various types of data relating to the distributed node 402, the distributed training node 404, devices (e.g., device 104 and/or device 106), the core network 204, and/or the communication network 102. The various types of data stored in the data store 414 can comprise, for example, data 418, such as collected data (e.g., distributed node-related data relating to conditions and/or characteristics associated with the distributed node 402), the statistical data relating to the distributed node 402 and/or other distributed nodes, other processed or derived data, metadata, and/or other type(s) of data, data relating to AI-based models, and/or other desired data. The local model repository 416 can be employed to store AI-based models 420, such as refined trained AI-based models that can be particularly trained for use by the distributed node 402, and model-related information (e.g., respective parameters, respective hyperparameters, and/or other respective metadata associated with the respective refined trained AI-based models 420) relating thereto. In certain embodiments, the model repository 416 can comprise nonvolatile memory and/or volatile memory usable for storage of data, such as described herein.

In accordance with various embodiments, the distributed node 402 can comprise the distributed training node 404 (or a portion thereof), or can be associated with (e.g., communicatively connected to) the distributed training node 404. In some embodiments, the distributed training node 404 can be in relatively close proximity (e.g., close physical and/or logical proximity) to the distributed node 402. Similarly, other respective distributed nodes of the distributed node group can comprise or can be in relatively close proximity to other respective distributed training nodes. In still other embodiments, if and as desired, a distributed training node can be associated with and can service more than one distributed node. In certain embodiments, such as when the distributed node 402 comprises the distributed training node 404, the data store 414 can comprise training data that can be utilized for training (e.g., node-specific or refined training) of trained AI-based models to generate refined trained AI-based models for use by the distributed node 402. In some embodiments, if the distributed training node 404 is separate from the distributed node 402, the distributed training node 404 can comprise its own data processor component, processor component, and data store, or can have access to a data processor component, processor component, and data store, to facilitate performance of operations by the distributed training node 404, such as described herein.

In still other embodiments, one or more respective distributed training nodes can be physically and/or logically located in the central node 108 and associated with (e.g., logically associated with) respective distributed nodes. As a non-limiting example, one or more respective distributed training nodes, such as the distributed training node 120 (or 404) and distributed training node 122, can be logical distributed training nodes that can be physically or deployment-wise within the central node 108, and can be mapped to respective distributed nodes, such as the distributed node 110 (or 402) and/or the distributed node 112.

In certain embodiments, the respective distributed nodes (e.g., 110 (or 402) and/or 112) can receive and/or collect respective condition-related information relating to respective conditions associated with the respective distributed nodes. For instance, the distributed node 402, employing the data collector component 406, can receive and/or collect condition-related information relating to the conditions associated with the distributed node 402, wherein the condition-related information can relate to respective conditions at respective times. The conditions can comprise, for example, operational conditions relating to operation of the distributed node (e.g., 110 (or 402) or 112), communication-related conditions associated with the distributed node, data traffic and processing load-related conditions, environmental conditions relating an environment associated with the distributed node, and/or other conditions associated with the distributed node or other network equipment or devices associated therewith. In some embodiments, the collected data (e.g., respective condition-related information and/or respective characteristics information) associated with respective distributed nodes can be or can comprise respective time series data (e.g., single dimensional and/or single variable time series data, and/or multi-dimensional and/or multi-variable time series data) comprising respective data segments, such as described herein.

The conditions can comprise or can relate to, for example, distortion, energy consumption, emissions, voltage bias (Vbias), component temperature, ambient temperature, transmission power (e.g., radio frequency (RF)_power (P) output (RF_Pout)), crest factor reduction (CFR) coefficients or parameters, digital predistortion (DPD) coefficients or parameters, and/or other conditions associated with the distributed node (e.g., 110 (or 402) or 112). The conditions also can relate to the time periods associated with such conditions, such as, for example, the time of day, day of week, month of year, or other time period.

The conditions also can comprise or can relate to, for example, signal-to-interference-plus-noise ratio (SINR), reference signal received power (RSRP), reference signal received quality (RSRQ), channel quality indicator (CQI), channel conditions, quality of service (QoS), perceived QoS, quality of experience (QoE) of a user, data traffic load, data processing load, throughput, latency, distortion, energy efficiency, and/or other desired conditions, metrics, or parameters that can indicate the features or qualities of conditions associated with the distributed node (e.g., 110 (or 402) or 112) and/or devices (e.g., 104 and/or 106) associated with the distributed node. In certain embodiments, the condition-related information also can comprise time data (e.g., timestamp or other time data that can indicate when a condition occurred or when an item of information relating to the condition was generated, event data (e.g., information relating to an event (e.g., sporting event, entertainment event, or other event where people using devices may gather) associated with a condition, such as an event that was taking place in proximity to the distributed node at the time the condition occurred), mapping data (e.g., mapping between a condition and another condition, mapping between a condition and a time of occurrence of the condition, mapping between a condition and an event, or other mapping relating to conditions), and/or other metadata relating to the conditions.

The conditions also can comprise or can relate to, for example, an environment associated with (e.g., in proximity to; or within a defined distance of) the distributed node (e.g., 110 (or 402) or 112). For instance, the conditions can relate to whether the distributed node is located in a relatively populated or congested area (e.g., a metropolitan area that can have a relatively higher and/or more dense population of people who can use various devices) or a more rural area (e.g., an area having a relatively lower and/or less dense population of people), whether the distributed node is located near a hill or other environmental barrier in one or more directions (e.g., distributed node located in proximity to or within a defined distance of a relatively large hill located to the north of the distributed node), whether the distributed node is located in a business district (e.g., an area where there is a significant number of businesses that may have a relatively large number of people using devices during the business day on weekdays, but a relatively lower number of people using devices during evening or nighttime hours and/or during weekends) or non-business district (e.g., a residential area), and/or whether the distributed node is located near a venue(s) (e.g., a sports venue, a concert venue, an entertainment venue, or other venue) where a relatively large number of people using devices may gather for events. The conditions also can relate to, for example, weather conditions (e.g., temperature, humidity, precipitation, air pressure, wind speed and direction, tornado, hurricane, flood, thunder, lightning, or other weather condition or event), climate conditions, electromagnetic interference, or other conditions that can have an effect on the operation of the distributed node.

In some embodiments, the respective distributed nodes (e.g., 110 (or 402) and/or 112) also can have and/or can collect respective characteristics-related information relating to respective characteristics (e.g., attributes, features, or properties) of or associated with the respective distributed nodes. For instance, the distributed node 402, employing the data collector component 406, can have and/or can collect characteristics-related information relating to the characteristics of or associated with the distributed node 402. The characteristics can relate to, for example, type(s) of cell(s) (e.g., sub-3 gigahertz (GHz) cell (e.g., sub-3 cell), and sub-6 GHz cell (e.g., sub-6 cell), millimeter wave (mmwave) cell, frequency division duplexing (FDD) cell, time division duplexing (TDD) cell, and/or other type of cell) of the distributed node, an accelerator function(s) (e.g., look-aside accelerator function, inline accelerator function, and/or other type of accelerator function) associated with the distributed node, an energy profile of the distributed node (e.g., use of energy by the distributed node in relation to (e.g., mapped to) conditions, time of day, day of week, event, and/or other factor), location of the distributed node, coverage area of the distributed node, and/or other characteristic, functionality, or feature of the distributed node. Some of the characteristics associated with the distributed node can relate to some conditions associated with the distributed node (e.g., an example characteristic can be that the distributed node can be located in an area where there can be a large hill located north of the distributed node, wherein such characteristic also can influence or can be a factor that can affect the communication-related conditions associated with the distributed node and can be an environmental condition associated with the distributed node). The distributed node 402 can store the condition-related information, characteristics information, and/or other information (e.g., as some of the data 418 (e.g., collected data, statistical data, and/or other data)) in the data store 414.

At various times, the central node 108, employing the data collector component 302, can receive the respective condition-related information and/or the respective characteristics information from the respective distributed nodes (e.g., 110 (or 402) and/or 112). For instance, the data collector component 302 can receive, obtain, and/or collect condition-related information and/or characteristics information from the distributed node 402. In some embodiments, the distributed node 402, employing the data processor component 408, can process (e.g., pre-process) and/or filter items of condition-related information and/or characteristics information, and/or can derive (e.g., determine or calculate) other condition-related information and/or other characteristics information (e.g., summary information, alert or alarm information, highest value or lowest value associated with a condition, average, median, or other value associated with a condition, or other derived item of information) based at least in part on the results of analyzing the items (e.g., raw items) of condition-related information and/or characteristics information, and can communicate the processed (e.g., raw, processed, filtered, and/or derived) items of condition-related information and/or characteristics information to the central node 108. In some embodiments, the data collector component 302 can store the respective condition-related information and/or the respective characteristics information associated with the respective distributed nodes (e.g., as some of the data 310 (e.g., the collected data)) in the data store 308.

In certain embodiments, the central node 108, employing the data processor component 304, can analyze the respective condition-related information and/or the respective characteristics information associated with the respective distributed nodes (e.g., 110 (or 402) and/or 112). As part of the analysis, the data processor component 304 can determine (e.g., compute or otherwise determine) the statistical variables that can characterize the respective data received (e.g., imported, collected, or obtained) the respective distributed nodes. The data processor component 304 can determine such statistical variables, which can characterize the data, on a per distributed node basis, or on an aggregated basis from multiple or all of the distributed nodes, and/or in shorter or longer time durations. The statistical variables can be utilized as some of the various inputs that can be desired by the data pre-processing functions to facilitate preparing the data for use in the training (e.g., multi-stage training) of AI-based models and/or for other desired uses. In some embodiments, the model manager node 116 (or the data processor component 304 or other component) can determine and/or generate statistics of a centralized aggregated dataset initially derived from data generated by multiple distributed nodes (e.g., 110 and 112), wherein these statistics can represent the overall dataset and/or per-distributed node data, and can provide the metrics that can be desired (e.g., wanted or useful) to generate (e.g., create) training datasets for joint (e.g., multi-node) and/or node-specific training stages for training of AI-based models.

In certain embodiments, based at least in part on the results of such analysis, the data processor component 304 can process (e.g., pre-process), filter, segment, or select respective items of condition-related information and/or characteristics information associated with the respective distributed nodes to facilitate determining and generating one or more groups (e.g., datasets) of training data that can be utilized to facilitate training AI-based models. As part of the analysis, the data processor component 304 can try to identify any similarities in the respective condition-related information and/or respective characteristics information associated with the respective distributed nodes. In some embodiments, the data processor component 304 can perform such data processing based at least in part on predetermined (e.g., pre-computed) inputs (e.g., input parameters) and/or configurable input parameters, wherein the respective input and configurable parameters can be customized (e.g., tuned, enhanced, or optimized) for the generation of multi-node training datasets (e.g., the first groups of training data). For instance, based at least in part on first predetermined input parameters and/or first configurable input parameters, and based at least in part on the analysis results, the data processor component 304 can process (e.g., pre-process), filter, segment, or select respective items of condition-related information and/or characteristics information associated with the respective distributed nodes to generate one or more respective first groups of training data (e.g., one or more groups of multi-node training data) that can be utilized to facilitate performing multi-node training of one or more AI-based models (e.g., as part of a first stage of multi-stage model training). In some embodiments, the one or more respective first groups of training data can be tailored or focused on similarities in the respective condition-related information and/or respective characteristics information associated with the respective distributed nodes, as identified (e.g., detected) by the data processor component 304 based at least in part on the analysis results. In certain embodiments, in connection with generating the training data, the data processor component 304 can execute data transformations and/or determine parameters relating to the training data, in accordance with the defined model management criteria, to achieve desired performance enhancement goals (e.g., optimization goals). The data processor component 304 can store the one or more respective first groups of training data (e.g., as the training data 312) in the data store 308 for use, if and when desired.

In some embodiments, the respective first groups of training data can relate to respective subgroups of conditions and/or respective subgroups of characteristics. For example, based at least in part on the first predetermined input parameters and/or the first configurable input parameters, and based at least in part on the analysis results, the data processor component 304 can process the data to generate a first group of training data that can relate to a first subgroup of conditions where the distributed nodes can be associated with a relatively high number (e.g., volume) of devices (e.g., distributed nodes near a busy business district where many users can be using devices), a second group (e.g., a different first or multi-node group) of training data that can relate to a second subgroup of conditions where the distributed nodes can be associated with a relatively lower number of devices (e.g., distributed nodes near a business district(s) at night or on weekends where a relatively lower number users can be using devices; or distributed nodes near a rural area where a relatively lower number users can be using devices), and/or another group of training data that can relate to another subgroup of conditions associated with the respective distributed nodes.

In certain embodiments, based at least in part on second predetermined input parameters and/or second configurable input parameters, and based at least in part on the analysis results, the data processor component 304 can process (e.g., pre-process), filter, segment, or select respective items of condition-related information and/or characteristics information associated with a particular distributed node (e.g., distributed node 110 (or 402) or distributed node 112) to generate one or more respective second groups of training data (e.g., one or more groups of node-specific training data) that can be utilized to facilitate performing node-specific training of one or more trained AI-based models (e.g., as part of a second stage of multi-stage model training by the distributed training nodes 120 and/or 122). wherein the respective second input parameters and respective second configurable parameters can be customized (e.g., tuned, enhanced, or optimized) for the generation of node-specific training datasets (e.g., the second groups of training data). In some embodiments, the respective second groups of training data can relate to respective subgroups of conditions and/or respective subgroups of characteristics associated with the particular distributed node. In certain embodiments, statistics relating to or representative of the node-specific data (e.g., relating to the particular distributed node), which can be utilized to determine and generate the second group of training data for node-specific training of the particular distributed node, can be different (or partially similar to) the statistics of the training dataset (e.g., the first group of training data) utilized in the multi-node training stage. The data processor component 304 can store the one or more respective second groups of training data (e.g., as the training data 312) in the data store 308 for use, if and when desired.

In some embodiments, the central node 108, employing the data processor component 304 and/or another component of the central node 108, can determine first parameters that can relate to and/or define the first threshold performance level, based at least in part on the results of analyzing the characteristics and/or statistics of the respective data (e.g., the respective condition-related information and/or the respective characteristics information) collected from the respective distributed nodes (e.g., 110 (or 402) and/or 112) of the group (e.g., cluster) of distributed nodes, wherein the first threshold performance level can be or can relate to (e.g., can correspond to or can be based at least in part on) the expected model precision that can be desired (e.g., wanted or needed) to be attained during the first stage model training (e.g., by the central training node 114). In certain embodiments, since the respective quality of the respective data collected from the respective distributed nodes can vary from distributed node to distributed node and/or over various times, the data processor component 304 can determine (e.g., automatically determine) an input parameter(s) that can be utilized for (e.g., applied to) the threshold performance level determination (e.g., threshold computation) to define the respective weights (e.g., respective weight values) that can be attributed or applied to the respective statistical characteristics of the respective data collected from the respective distributed nodes, in accordance with the defined model management criteria. Accordingly, in certain embodiments, the central node 108, employing the data processor component 304 and/or another component of the central node 108, can determine the first parameters that can relate to and/or define the first threshold performance level, based at least in part on the results of analyzing the characteristics and/or statistics of the respective data collected from the respective distributed nodes, as such characteristics and/or statistics of the respective data are respectively weighted based at least in part on the respective weights. The data processor component 304 can store information (e.g., parameters, hyperparameters, other metadata, and/or other information) relating to the first threshold performance level in the data store 308 and/or can provide such information to the model manager node 116, wherein the model manager node 116 can include such information in a model training request to enable the central training node 114 to know, determine, and/or apply the first threshold performance level and/or corresponding parameters during the first stage of model training of an AI-based model. It is noted that the first threshold performance level can be different at different times depending in part on various factors, including the quality of the collected data, the desired performance target for model training, the type of model, and/or another factor(s).

In some embodiments, with regard to the second stage (e.g., node-specific) model training, the data processor component 304 can estimate, predict, and/or determine an amount of improvement in performance of the trained AI-based model that can be achieved during the second stage, node-specific training of the trained AI-based model, and/or can determine the second threshold level of performance to utilize during the second stage, node-specific training of the trained AI-based model, based at least in part on the results of evaluating (e.g., comparing) the statistics of the node-specific training datasets (e.g., the second groups of training data) and the statistics of the multi-node training datasets (e.g., the first groups of training data). In certain embodiments, the statistics (e.g., statistical data) can comprise or can relate to validation of the performance of each distributed node with respect to the two types of models (e.g., multi-node trained AI-based model versus refined (e.g., node-specific) trained AI-based model), and the measured performance, for each or either of the AI-based models, of the distributed node with respect to the desired outcome or target performance goal (e.g., performance enhancement goal), as such goal can be indicated or specified in the defined model management criteria (e.g., performance criteria of the defined model management criteria). In some embodiments, the statistics can relate to the variance in the data of the trained AI-based model using multiple distributed nodes versus the costs (e.g., energy, time, complexity, and/or other cost) associated with the second (e.g., node-specific) model training stage for further model training to generate a refined trained AI-based model with respect to the distributed node, as such costs can be indicated or specified in the defined model management criteria. In still other embodiments, the statistics can involve taking the input data that can be obtained or collected by the distributed node 402 at a rate on the order of that of the symbol rate, and processing (e.g., by the data processor component 408 of the distributed node 402) the data to determine and generate statistical data that can be representative of the collected data, but desirably can be less complex data and/or a lower amount of data than the collected data, wherein the distributed node can transfer such statistical data to the central node (e.g., instead of communicating the higher amount of collected data). Such generation of statistical data, which can be less complex and/or a lower amount of data than the collected data, can be desirable and/or utilized, for example, when the verbose data (e.g., the larger amount of collected data) can be shown, over time, to be no better source for generating training data for model training than the statistical data representative of that same verbose data, without transferring all of that collected data off-node from the distributed node to the central node, which desirably can make the data curation and management less complex and less costly (e.g., less costly with regard to resource usage, time usage, and/or energy usage).

Based at least in part on the amount of improvement in performance of the trained AI-based model that can be achieved during the second model training stage, the data processor component 304 can determine input parameters that can relate to and/or define the second threshold performance level, wherein the second threshold performance level can be or can relate to (e.g., can correspond to or can be based at least in part on) the expected model precision that can be desired (e.g., wanted or needed) to be attained during the second stage model training (e.g., by the distributed training node(s) 120 and/or 122). In certain embodiments, the data processor component 304 can manage (e.g., control, modify, or adjust) these parameters (e.g., from the initial parameter determination based on the amount of improvement in performance) on a per distributed node basis, depending in part on the desired first threshold performance level(s) defined for the joint model training (e.g., the first stage or multi-node model training) and/or the particular distributed node. The data processor component 304 can store information (e.g., parameters, hyperparameters, other metadata, and/or other information) relating to the second threshold performance level in the data store 308 and/or can provide such information to the model manager node 116, wherein the model manager node 116 can include such information in a model training request to enable the distributed training node(s) (e.g., 120 and/or 122) to know, determine, and/or apply the second threshold performance level and/or corresponding parameters during the second stage of model training of a trained (e.g., multi-node trained) AI-based model(s). It is noted that the second threshold performance level can be different at different times depending in part on various factors, including the quality of the collected data, the desired performance target for model training (e.g., second stage model training), the type of model, the particular distributed node, and/or another factor(s).

The system 100 (e.g., employing the central node 108 and distributed training nodes), by employing the enhanced techniques and enhanced model management algorithms described herein, can desirably (e.g., automatically, suitably, efficiently, enhancedly, or optimally) achieve (and its goals and advantages can include), for each distributed node (e.g., distributed node 110 (or 402) and/or distributed node 112), a respective refined (e.g., adapted, customized, and/or node-specific) trained AI-based model (e.g., after performance of the distributed model training) that can have a desirably higher performance than the relatively lower (e.g., minimum) defined performance of generic or multi-node trained AI-based models, wherein the execution of the AI-based algorithms and processes based on the respective refined trained AI-based models can utilize relatively light-weight operations, can be resource-wise (e.g., can utilize less or minimum computational, time, and/or other resources), and can have reduced energy consumption, as compared to the generic or multi-node trained AI-based models. The system 100 (e.g., employing the central node 108 and distributed training nodes), by employing the enhanced techniques and enhanced model management algorithms described herein, also can desirably (e.g., automatically, suitably, efficiently, enhancedly, or optimally) enhance (e.g., improve, maximize, or optimize) the average AI-based model performance across all of the distributed nodes (e.g., 110 (or 402) and/or 112), and can enhance the overall training load for all nodes (e.g., central node 108 and its constituent nodes, the distributed training nodes, and the distributed nodes) and both stages of model training (e.g., as further goals and advantages of the system 100). The system 100, by employing the enhanced techniques and enhanced model management algorithms described herein, can desirably customize the model performance targeted (e.g., can customize and optimize the threshold performance level) at the joint (e.g., multi-node) training stage to the training datasets created from the data collected from the distributed nodes, instead of, for example, merely using a preconfigured threshold performance level, and such customization of the threshold performance levels can allow the system 100 to further enhance (e.g., improve or optimize) the separation between the joint model training (e.g., by the central training node) and distributed model training (e.g., by the distributed training nodes), which can provide additional gains (e.g., additional improvements) for both the joint model training and the distributed model training in the multi-stage training of AI-based models.

In certain embodiments, the central node 108, employing the model manager node 116, can manage (e.g., control and/or coordinate) the training of one or more AI-based models based at least in part on the one or more groups of training data (e.g., the one or more first groups of training data for multi-node training, and/or the one or more second groups of training data for node-specific training), respective groups of parameters and/or hyperparameters, and/or respective threshold performance levels, in accordance with the defined model management criteria. The model manager node 116 can manage and coordinate initiation of the respective model training stages (e.g., first stage, multi-node training stage, and second stage, node-specific training stage), transfer or facilitate transfer of respective training datasets and the model artifacts or metadata to the respective training nodes (e.g., central training node or desired distributed training node(s)). In some embodiments, to facilitate managing such model training, the model manager node 116 can determine and generate one or more mappings of respective groups of training data, respective groups of parameters and/or hyperparameters, and/or other respective model training-related items of information to respective groups of distributed nodes (e.g., where there can be one or more clusters of distributed nodes associated with the central node 108). For instance, the model manager node 116 can determine and generate one or more first mappings of one or more respective first groups of training data (and/or one or more respective groups of parameters and/or hyperparameters, and/or one or more other respective model training-related items of information) to a first group of distributed nodes, one or more second mappings of one or more respective second groups of training data (and/or one or more respective other groups of parameters and/or hyperparameters, and/or one or more other respective model training-related items of information) to a second group of distributed nodes, and/or one or more other mappings of one or more respective other groups of training data (and/or one or more respective other groups of parameters and/or hyperparameters, and/or one or more other respective model training-related items of information) to another group of distributed nodes, to facilitate training (e.g., multi-node training) of respective AI-based models for the respective groups of distributed nodes using respective training data that can be desirable (e.g., useful, wanted, suitable, relevant, enhanced, or optimal) for training of the respective AI-based models.

In certain embodiments, to facilitate managing such model training, the model manager node 116 can generate model training requests that can be communicated to the central training node 114 (e.g., for first stage or multi-node model training) and/or the distributed node (e.g., distributed node 110 (or 402) or 112, for second stage or node-specific model training) to initiate and manage the desired model training. In some embodiments, a model training request can comprise instructions for training a desired trained AI-based model, can indicate or specify the desired trained AI-based model (e.g., stored in the model repository 118) that is to undergo second stage (e.g., node-specific) model training, can indicate or specify the group of training data, or can comprise the group of training data, can indicate or can comprise the group of parameters and/or hyperparameters, can indicate the threshold performance level, and/or can comprise information (e.g., metadata (e.g., characteristic training dataset information and/or other metadata)) relating thereto, that can be utilized to facilitate training of an AI-based model (e.g., by the central training node 114 for the first model training stage, or a distributed node for the second model training stage). If the model training request does not include the group of training data or other model training-related information, the central training node 114 can access and retrieve the group of training data or the other model training-related information from the data store 308, based at least in part on training data-related information (e.g., mapping or other information) contained in the model training request.

In accordance with various embodiments, and in accordance with and/or in response to one or more model training requests, the central training node 114 can train one or more respective AI-based models (e.g., the AI-based model specified in the model training request), based at least in part on application (e.g., input) of one or more respective groups of training data to the one or more respective AI-based models, to generate one or more respective trained AI-based models, in accordance with the defined model management criteria. In some embodiments, as part of a first stage of model training, the central training node 114 can apply (e.g., input) a first group of training data and a first subgroup (of a first group) of parameters and/or hyperparameters to an AI-based model to facilitate training (e.g., multi-node training) the AI-based model. Based at least in part on the application of the first group of training data and the first subgroup of parameters and/or hyperparameters to the AI-based model, the central training node 114 can train the AI-based model to generate a trained AI-based model, in accordance with the defined model management criteria.

In certain embodiments, after an iteration of training of the AI-based model, the central training node 114 can evaluate and/or determine whether the trained AI-based model satisfies (e.g., meets or exceeds; or is at or greater than) a first threshold performance level relating to generating AI-based output result data (e.g., a first performance level relating to accuracy and/or other performance metrics of inferences, probabilities, and/or other AI-based output result data), in accordance with the defined model management criteria. In some embodiments, to facilitate such training evaluation, the central training node 114 can utilize a validation dataset, which can be or can comprise a portion of the first group of training data, to evaluate (e.g., compare against or otherwise evaluate) the performance of the trained AI-based model to determine whether such performance by the trained AI-based model satisfies the first threshold performance level. In certain embodiments, as described herein, the first threshold performance level employed during the first model training stage can be a relatively lower threshold performance level than the second threshold performance level that can be employed during the second model training stage (e.g., by the distributed training node 120), which can desirably reduce the processing load and the amount of resources used to train the AI-based model to generate the trained AI-based model during the first model training stage, although, in other embodiments, if and as desired the first threshold performance level can be the same as the second threshold performance level. Accordingly, in some embodiments, the parameters and/or hyperparameters employed during the first model training stage can be tuned (e.g., tuned, adjusted, or tailored by the central training node 114) to facilitate desirable first stage (e.g., multi-node) model training of the AI-based model to generate the trained AI-based model that can satisfy the first threshold performance level, such as described herein.

If the central training node 114 determines that the trained AI-based model satisfies the first threshold performance level, the central training node 114 can determine that the trained AI-based model is desirably (e.g., suitably, sufficiently, or optimally) trained at this first model training stage, and can discontinue further training of the trained AI-based model. If, instead, the central training node 114 determines that the trained AI-based model does not satisfy the first threshold performance level after the iteration of model training, the central training node 114 can determine that a next iteration of model training can be performed to further train the trained AI-based model to work towards having the trained AI-based model achieve the desired first threshold performance level. In certain embodiments, during the next model training iteration, to facilitate improving performance of the trained AI-based model, the central training node 114 can adjust (e.g., tune) or otherwise manage the respective hyperparameters and/or respective parameters of the parameter group (e.g., can employ a different subgroup of the first group of parameters and/or hyperparameters) and/or can utilize the same first group of training data or a different group (e.g., a different first group) of training data (e.g., although the parameters relating to the first threshold performance level typically can remain the same). The central training node 114 can apply the respective adjusted hyperparameters and/or respective adjusted parameters, and the applicable first group of training data, to the trained AI-based model to continue training of the trained AI-based model. In some embodiments, the central training node 114 can continue performing iterations of model training to train the trained AI-based model, including making appropriate adjustments to the respective hyperparameters and/or respective parameters, and/or to the training dataset, and including evaluating performance of the trained AI-based model after each model training iteration, until the central training node 114 determines that the first threshold performance level is satisfied, or, if still not satisfied, until a defined model training suspension criterion (e.g., a defined maximum number of model training iterations) is determined to be satisfied (e.g., met, reached, or breached). In certain embodiments, after the central training node 114 determines that the trained AI-based model has attained a first performance level that satisfies the first threshold performance level, the central training node 114 can discontinue training of the trained AI-based model, and can store the trained AI-based model, and information (e.g., metadata) relating thereto, in the model repository 118.

In some embodiments, the central training node 114 can similarly train (e.g., perform multi-node training of) one or more other AI-based models, based at least in part on one or more respective first groups of training data, one or more respective first groups of parameters and/or hyperparameters, and/or other model training-related information, to generate one or more other trained AI-based models (e.g., trained model variants) that can relate to various features (e.g., various respective conditions and/or characteristics) associated with the group of distributed nodes (e.g., for one or more groups of distributed nodes), such as described herein. The central training node 114 can store the one or more trained AI-based models, and respective information (e.g., respective metadata) relating thereto, in the model repository 118.

In accordance with various embodiments, and in accordance with and/or in response to one or more model training requests, the distributed training node 404 can train one or more respective trained AI-based models, based at least in part on application (e.g., input) of one or more respective groups of training data to the one or more respective trained AI-based models, to generate one or more respective refined trained AI-based models that can be utilized by the distributed node 402 (or another distributed node), in accordance with the defined model management criteria. In some embodiments, the distributed training node 404 can receive a request for model training (e.g., node-specific model training) from the model manager node 116, wherein the model training request can indicate or specify the trained AI-based model that is to utilized for the second stage model training, can indicate or specify the group (e.g., second group) of training data, or can comprise the group of training data, can indicate or can comprise the group (e.g., second group) of parameters and/or hyperparameters, can indicate the second threshold performance level, and/or can comprise information (e.g., metadata (e.g., characteristic training dataset information and/or other metadata) and/or other node-specific information) relating thereto, that can be utilized to facilitate training of a trained AI-based model to generate a refined trained AI-based model, as part of the second stage of model training. In certain embodiments, based at least in part on the model training request, the distributed training node 404 can access or receive the trained AI-based model and associated information (e.g., metadata and/or node-specific information) from the model repository 118. In some embodiments, the distributed training node 404 can access or receive the trained AI-based model and associated information from the model repository 118 via a desired (e.g., suitable or optimal) interface that can communicatively couple (e.g., connect) the distributed training node 404 to the central node 108 (e.g., to the model repository 118 of the central node 108) and can support the transfer of information (e.g., trained AI-based models, training datasets, parameters, hyperparameters, metadata, and/or other information) between the central node 108 and the distributed training node 404. In certain embodiments, the interface can be an open fronthaul management (M)-plane of an O-RAN deployment, although, in other embodiments, the interface can be a different type of suitable interface. In accordance with various embodiments, the distributed training node 404 can receive node-specific information (e.g., condition-related information, characteristics information, and/or other information relating to the distributed node 402) from the distributed node 402 and/or the central node 108.

In some embodiments, based at least in part on the model training request, the distributed training node 404 can apply (e.g., input) a second group of training data and a second subgroup (of a second group) of parameters and/or hyperparameters to the trained AI-based model to facilitate training (e.g., refining or further training, and/or performing node-specific training of) the trained AI-based model. Based at least in part on the application of the second group of training data and the second subgroup of parameters and/or hyperparameters to the trained AI-based model, the distributed training node 404 can train the trained AI-based model to generate, or to progress towards generating, a refined trained AI-based model associated with the distributed node 402, in accordance with the defined model management criteria.

In some embodiments, after an iteration of second-stage training of the trained AI-based model, the distributed training node 404 can evaluate and/or determine whether the trained AI-based model satisfies (e.g., meets or exceeds; or is at or greater than) the second threshold performance level relating to generating AI-based output result data (e.g., a second performance level relating to accuracy and/or other performance metrics of inferences, probabilities, and/or other AI-based output result data), in accordance with the defined model management criteria. In some embodiments, to facilitate such training evaluation, the distributed training node 404 can utilize a validation dataset, which can be or can comprise a portion of the second group of training data, to evaluate (e.g., compare against or otherwise evaluate) the performance of the trained AI-based model (e.g., the refined or further trained AI-based model) to determine whether such performance by the trained AI-based model satisfies the second threshold performance level. In certain embodiments, the second threshold performance level employed during the second model training stage typically can be a relatively higher threshold performance level than the first threshold performance level that can be employed during the first model training stage (e.g., by the central training node 114), such as described herein. Accordingly, in some embodiments, the parameters and/or hyperparameters employed during the second model training stage can be tuned (e.g., tuned, adjusted, or tailored by the distributed training node 404 and/or model manager node 116) to facilitate desirable second stage (e.g., node-specific) model training of the trained AI-based model to generate the refined trained AI-based model that can satisfy the second threshold performance level, such as described herein.

In certain embodiments, if the distributed training node 404 determines that the refined trained AI-based model satisfies the second threshold performance level, the distributed training node 404 can determine that the refined trained AI-based model is desirably (e.g., suitably, sufficiently, enhancedly, or optimally) trained, and can discontinue further training of the refined trained AI-based model. In some embodiments, if, instead, the distributed training node 404 determines that the trained (e.g., further trained) AI-based model does not satisfy the second threshold performance level after the iteration of model training, the distributed training node 404 can determine that a next iteration of second stage model training can be performed to further train the trained AI-based model to work towards having the trained AI-based model becoming the refined trained AI-based model that can achieve the desired second threshold performance level. In certain embodiments, during the next second stage model training iteration, to facilitate improving performance of the trained AI-based model, the distributed training node 404 can adjust (e.g., tune) or otherwise manage the respective hyperparameters and/or respective parameters of the parameter group (e.g., can employ a different subgroup of the second group of parameters and/or hyperparameters) and/or can utilize the same second group of training data or a different group (e.g., a different second group) of training data (although the parameters relating to the second threshold performance level typically can remain the same). The distributed training node 404 can apply the respective adjusted hyperparameters and/or respective adjusted parameters, and the applicable second group of training data, to the trained AI-based model to continue training of the trained AI-based model.

In some embodiments, the distributed training node 404 can continue performing iterations of second stage model training to train the trained AI-based model, including making appropriate adjustments to the respective hyperparameters and/or respective parameters, and/or to the training dataset, and including evaluating performance of the trained AI-based model after each model training iteration, until the distributed training node 404 determines that the second threshold performance level is satisfied, or, if still not satisfied, until a defined model training suspension criterion (e.g., a defined maximum number of second stage model training iterations) is determined to be satisfied. In certain embodiments, after the distributed training node 404 determines that the trained AI-based model is the refined trained AI-based model that has attained a second performance level that satisfies the second threshold performance level, the distributed training node 404 can discontinue training of the refined trained AI-based model, and can store the refined trained AI-based model, and information (e.g., metadata and node-specific information) relating thereto, in the model repository 118 of the central node 108 and/or in the local model repository 416 (e.g., as model 420 stored in a model library or repository) of the distributed node 402 (and/or in the data store of the distributed training node 404). In some embodiments, as a result of the second stage (e.g., node-specific) model training, the refined trained AI-based model can be tailored (e.g., customized or adapted) to account for the particular or unique conditions and characteristics associated with the distributed node 402 in connection with the refined trained AI-based model generating AI-based output result data, such that the AI-based output result data relating to the distributed node 402 generated by the refined trained AI-based model can be enhanced, as compared to other AI-based output result data relating to the distributed node 402 that otherwise may have been generated by a generic or multi-node trained AI-based model, and such that the execution of the AI-based processing function (e.g., AI-based optimization algorithm) based on the refined trained AI-based model can utilize relatively light-weight operations, can be resource-wise (e.g., can utilize less, fewer, or minimum computational, time, and/or other resources), and can have reduced (e.g., minimized or lower) energy consumption, as compared to the generic or multi-node trained AI-based model.

In some embodiments, the distributed training node 404 can similarly train (e.g., perform node-specific training of) one or more other trained AI-based models, based at least in part on one or more respective second groups of training data, one or more respective second groups of parameters and/or hyperparameters, and/or other model training-related information, to generate one or more other refined trained AI-based models (e.g., trained model variants) that can relate to various features (e.g., various respective conditions and/or characteristics) associated with the distributed node 402, such as described herein. For instance, the distributed training node 404 can train a first refined trained AI-based model (e.g., a first variant of a refined trained AI-based model) that can be utilized by the distributed node 402 when the distributed node 402 is experiencing a first set of conditions (e.g., a first (e.g., higher) level of distributed node or network congestion, a first time period (e.g., business hours on a workday in a business district), and/or conditions relating to a first event), and/or has a first set of characteristics, can train a second refined trained AI-based model (e.g., a second variant of a refined trained AI-based model) that can be utilized by the distributed node 402 when the distributed node 402 is experiencing a second set of conditions (e.g., a second (e.g., lower) level of distributed node or network congestion, a second time period (e.g., nighttime hours or weekend hours in a business district with most businesses closed at night or on weekends), and/or conditions relating to a second event) and/or has a second set of characteristics, and/or can train another refined trained AI-based model (e.g., another variant of a refined trained AI-based model) that can be utilized by the distributed node 402 when the distributed node 402 is experiencing another set of conditions and/or has another set of characteristics, in accordance with the defined model management criteria (e.g., defined model selection criteria of the defined model management criteria). The distributed training node 404 can store the one or more refined trained AI-based models in the model repository 118 of the central node 108 and/or in the local model repository 416 of the distributed node 402 (and/or in the data store of the distributed training node 404).

With further regard to the second group(s) of training data that can be utilized for second stage model training, while, in some embodiments, the distributed training node 404 can receive the second group(s) of training data from the central node 108, in accordance with various embodiments, the distributed training node 404 (e.g., employing the data processor component 408 or its own data processor component) can determine and generate a second group of training data, and/or can augment (e.g., modify, update, or adapt) a second group of training data, received from the central node 108, to generate an augmented second group of training data, based at least in part on the results of analyzing, processing, filtering, and/or selecting respective items of condition-related information and/or characteristics information, in a manner that can be the same as or similar to how the data processor component 304 generates second groups of training data, such as described herein. In that regard, it is noted that the distributed node 402 (e.g., employing the data collector component 406) can be receiving or collecting data relating to the conditions and/or characteristics in real time or near real time, and the distributed training node 404 can utilize (e.g., incorporate, analyze, and/or process) this data to determine the respective conditions and/or characteristics associated with the distributed node 402 (e.g., at a given time), and generate a second group of training data and/or augment a received second group of training data to generate an augmented second group of training data. In some embodiments, real time can be defined as a period of time equal to, or based on, a symbol period relating to communication of a symbol in a communication network in the context of 5G or other xG.

In accordance with various embodiments, one or more other respective distributed training nodes (e.g., distributed training node 122) associated with one or more other respective distributed nodes (e.g., distributed node 112) can perform second stage model training on respective trained (e.g., multi-node trained) AI-based models to generate respective refined trained AI-based models for use by the respective distributed nodes, in a same or similar manner as described herein with regard to the distributed training node 404 and the distributed node 402. Those other respective refined trained AI-based models, and respective associated model-related information, can be stored in the model repository 118 in the data store 308 of the central node 108 and/or in the other respective local model repositories of the other respective distributed nodes (and/or in the other respective data stores of the other respective distributed training nodes).

In accordance with various embodiments, the distributed node 402 can determine and select a desirable refined trained AI-based model (e.g., 422) from its local model repository 416 or from the model repository 118 of the central node 108, based at least in part on the conditions and/or characteristics associated with the distributed node 402 and other information relating to the respective refined trained AI-based models of the model group, in accordance with the defined model management criteria, such as described herein. In some embodiments, the distributed node 402, employing the data processor component 408 (e.g., local data analyzer and processor), can analyze data (e.g., in real time or near real time) relating to conditions and/or characteristics associated with the distributed node 402 and/or the devices (e.g., 104 and/or 106) associated with the distributed node 402 at a desired time (e.g., over a recent time period, over a current time period, or with regard to anticipated or predicted conditions and/or characteristics over a future time period (e.g., in the near future)). Based at least in part on the results of the analysis of the data, the data processor component 408 or the model selector component 410 can determine (e.g., in real time or near real time) the conditions and/or the characteristics associated with the distributed node 402 and/or the devices at the desired time. Based at least in part on the conditions and/or the characteristics associated with the distributed node 402 and/or the devices at the desired time and the other model-related information, the model selector component 410 can determine (e.g., identify, in real time or near real time) a desirable refined trained AI-based model (e.g., 422) from the group of refined trained AI-based models associated with the distributed node 402 that can be stored in the local model repository 416 (e.g., the local model library or repository of the distributed node 402) or stored in the model repository 118 of the central node 108, in accordance with the defined model management criteria, wherein the desirable refined trained AI-based model can be the desirable (e.g., most suitable or optimal) model for the distributed node 402 to utilize in connection with the desired time (e.g., at that time or a time in the near future), given the conditions and/or the characteristics associated with the distributed node 402 and/or the devices at the desired time. The model selector component 410 can access and/or retrieve the desired refined trained AI-based model from the local model repository 416 of the distributed node 402 or the model repository 118 of the central node 108. Once instantiated by the distributed node 402, the desired (e.g., selected) refined trained AI-based model can determine and generate inferences, probabilities, and/or other AI-based output result data, based at least in part on the results of analyzing (e.g., performing an AI-based analysis on) data (e.g., condition-related data, characteristics data, and/or other data) input to the refined trained AI-based model. In accordance with various embodiments, the desired refined trained AI-based model can perform the inference operations and/or other AI-based operation on a continuous, periodic, or dynamic basis, depending in part on the performance enhancement goals, in accordance with the defined model management criteria.

In some embodiments, to facilitate on-node model selection by the distributed node 402, the model manager node 116 of the central node 108 can instantiate or facilitate instantiating a state machine (e.g., model selector state machine) on the distributed node 402, wherein the model selector component 410 of the distributed node 402 can utilize the state machine to facilitate selection of a desirable refined trained AI-based model from the group of refined trained AI-based models associated with the distributed node 402. For instance, the model manager node 116 can communicate to the model selector component 410 of the distributed node 402, via a desired (e.g., suitable or useful) interface between the model manager node 116 and the model selector component 410, information relating to the state machine (e.g., information relating to the state machine framework) and/or other desired information (e.g., respective metadata, including respective artifacts, associated with respective AI-based models, configuration data (e.g., relating to performance enhancement goals and associated model selection criteria), and/or other data) to facilitate model selection/reselection by the model selector component 410. In certain embodiments, the on-node state machine can rely on the statistical data of the clustered data (e.g., respective condition-related data, characteristics data, and/or other data associated with the group of distributed nodes) that was used for the AI-based model training and validation, such as described herein. In some embodiments, the model selector component 410, employing the state machine, can determine a desirable refined trained AI-based model (e.g., 422) to select from the model group associated with the distributed node 402 based at least in part on independent and dependent input data (e.g., real time or near real time independent and dependent input data, such as desired independent condition-related information and desired dependent condition-related information) associated with the distributed node 402, performance database feedback information (e.g., statistical information, and/or model-related performance information, such as, for example, dependent performance outcome information relating to performance of the distributed node 402, model, and/or communication network, and/or other feedback and/or performance information relating to the distributed node 402, model, and/or network), configuration state data associated with the distributed node 402, and/or other information, in accordance with the defined model selection criteria (of the defined model management criteria).

Once the desirable refined trained AI-based model (e.g., 422) is selected, the refined trained AI-based model can operate on, including performing AI-based operations and analysis on, data (e.g., local and/or collected data) associated with the distributed node 402 to generate output data (e.g., AI-based output result data) that can be provided to and consumed (e.g., utilized) by the distributed node 402 to affect operational settings of the distributed node 402 and/or another component(s) or device(s) associated with the distributed node 402. In certain embodiments, the desirable refined trained AI-based model can monitor (e.g., continuously, dynamically, or periodically monitor, in real time or near real time) the conditions, including key performance parameters (e.g., key performance indicators (KPIs)), of the distributed node 402. While the desirable refined trained AI-based model is monitoring the conditions, if such model is determined to be functioning such that the inputs (e.g., independent and dependent input data) to the model are not varying to a degree such that output updates can be desired (e.g., wanted or required), the model selector component 410 can determine that desirable enhanced performance (e.g., desirably optimized performance) of the refined trained AI-based model and/or the distributed node 402 has been achieved, and no further enhancement (e.g., optimization) point improvement is deemed sufficiently useful (e.g., valuable or beneficial) enough to pursue, and the refined trained AI-based model can continue to function without change. Desirable enhanced (e.g., optimized) performance of the refined trained AI-based model and/or the distributed node 402 can be achieved, for example, if, based at least in part on the parameters present in the refined trained AI-based model, no further enhancement for AI-based operations and/or operations of the distributed node 402 may be sufficiently useful enough to pursue (e.g., cost of pursuing further optimization may be outweighed by the potential benefit of doing so).

In some embodiments, an enhancement quality indicator can be employed with the state machine to facilitate initiation (e.g., triggering or prompting) of model reselection within the state machine to facilitate transition between refined trained AI-based models of the model group, or at least a determination of whether there is to be a transition between refined trained AI-based models of the model group. For example, in a case where it is determined that no further performance enhancement may be sufficiently useful enough to pursue, the model can pause (e.g., automatically or dynamically pause) until a change (e.g., threshold change) in the input parameters to the model can result in the enhancement quality indicator being sent (e.g., communicated) to the model selector component 410 and/or associated state machine. The enhancement quality indicator can prompt the model selector component 410 and/or state machine to determine whether there is to be a change (e.g., transition or switch) from the current refined trained AI-based model to another refined trained AI-based model of the model group associated with the distributed node 402 to enhance operation of the performance of AI-based operations by the selected model and/or operations of the distributed node 402 overall, in accordance with the defined model selection criteria, such as described herein. In certain embodiments, the model selector component 410 can apply a desired hysteresis and/or a low pass filter (e.g., integration) to the mechanism (e.g., the state machine) to avoid or inhibit an undesirable frequency of updates (e.g., transitioning) to the present operating refined trained AI-based model for the distributed node 402, in accordance with the defined model selection criteria, as performing model reselection determinations and transitioning between refined trained AI-based models too frequently in order to pursue relatively minimal performance enhancement for the distributed node 402 may result in degraded performance of the distributed node 402 overall (e.g., the cost (e.g., time cost, resource usage cost, energy usage cost, model reselection and transition costs, and/or other costs) of too frequently performing model reselection determinations and transitioning between refined trained AI-based models can outweigh any relatively minimal performance enhancement that may be achieved for the distributed node 402 from it).

In some embodiments, network-level node specifications (e.g., requirements) can drive (e.g., trigger or result in) reconfiguration associated with the distributed node 402. In certain embodiments, such reconfiguration can drive model reselection based at least in part on upcoming network specifications that can be provided to the model selector component 410, such as described herein.

There can be differing outcomes for enhancement of performance of the distributed node 402. Some can be provided (e.g., dictated or specified) to the distributed node 402 through network-driven configuration settings for operational specifications (e.g., requirements). For example, a performance enhancement (e.g., optimization) goal (and a corresponding model selection criterion) can be targeted to reducing or minimizing energy consumption by the distributed node 402. As another example, a performance enhancement goal (and a corresponding model selection criterion) can be to increase or maximize link performance associated with the distributed node 402, while reducing or minimizing distortion or emissions associated with the distributed node 402. There can be various other desired performance enhancement goals (and corresponding model selection criteria) that can be employed or implemented by the core network 204, the central node 108, and/or the distributed node 402 to facilitate achieving desirable (e.g., suitable, enhanced, or optimized) performance of the distributed node 402 and/or the refined AI-based models employed by the distributed node 402, including such goals described herein. The enhancement of performance and associated model selection can therefore be said to be goal specific. Such performance enhancement goals can be included as parameters (e.g., performance enhancement parameters) in the generated data utilized to create the training datasets (e.g., groups of training data) and can be embedded as artifacts in the metadata associated with each AI-based model, for example, to facilitate model selection.

With further regard to the state machine and corresponding model selection process (e.g., method), the model selector component 410 initially can have a first refined trained AI-based model (e.g., first node-specific model variant), of the model group associated with the distributed node 402, instantiated for use to perform various operations for the distributed node 402. In some embodiments, the selection parameters of the instantiated first refined trained AI-based model and the other refined trained AI-based models (e.g., other node-specific model variants) of the model group (e.g., available in the local model repository 416 of the distributed node 402 and/or the model repository 118 of the central node 108) can be configured to the model selector component 410 from the respective metadata associated with the respective refined trained AI-based models of the model group.

In some embodiments, in accordance with the state machine and corresponding model selection process, the distributed node 402, employing the data collector component 406, can monitor (e.g., in real time or near real time) respective conditions (e.g., the operational conditions, communication-related conditions, data traffic and processing load-related conditions, environmental conditions, and/or other conditions) associated with the distributed node 402. Based at least in part on the monitoring, the data collector component 406 can receive (e.g., obtain or collect) respective condition-related information relating to the respective conditions associated with the distributed node 402. In certain embodiments, the distributed node 402, employing the data processor component 408, can analyze (e.g., in real time or near real time) the respective condition-related information to facilitate determining the respective conditions associated with the distributed node 402. In some embodiments, the first refined trained AI-based model can determine and/or indicate the respective conditions associated with the distributed node 402 based at least in part on the results of analyzing respective condition-related information relating to the respective conditions associated with the distributed node 402.

In some embodiments, in accordance with the state machine and corresponding model selection process, based at least in part on the respective conditions associated with the distributed node 402, the model selector component 410 can determine whether a threshold amount of change in the respective conditions has been satisfied (e.g., breached; met or exceeded; or is at or greater than), in accordance with the defined model selection criteria. In certain embodiments, the defined model selection criteria can comprise threshold information that can indicate or specify the threshold amount of change (e.g., threshold change in conditions or in performance) to be employed to facilitate model selection determinations. In some embodiments, the model selector component 410 can determine whether the threshold amount of change in the respective conditions has been satisfied based at least in part on whether the model selector component 410 has received an enhancement quality indicator from the first refined trained AI-based model, wherein no enhancement quality indicator being received by the model selector component 410, or an enhancement quality indicator of a first value (e.g., 0; or alternatively 1) being received by the model selector component 410, can indicate that the threshold amount of change in the respective conditions has not been satisfied, and wherein an enhancement quality indicator of a second value (e.g., 1; or alternatively 0) being received by the model selector component 410 can indicate that the threshold amount of change in the respective conditions has been satisfied.

If, based at least in part on the results of comparing the respective conditions to the applicable threshold amount of change, or based at least in part on the enhancement quality indicator, the model selector component 410 determines that the threshold amount of change in the respective conditions has not occurred or is not detected, the model selector component 410 can determine whether there is a configuration update that relates to (e.g., that can impact) the first (e.g., the current and/or instantiated) refined trained AI-based model that is being utilized by the distributed node 402, based at least in part on whether the model selector component 410 has received configuration update information related to the first refined trained AI-based model or other information indicating whether there is such a configuration update. If the model selector component 410 determines that there is no configuration update that relates to the first refined trained AI-based model, the model selector component 410 can determine that, at this time, there is not to be a transition (e.g., switch or model reselection) from the distributed node 402 utilizing the first refined trained AI-based model to a second refined trained AI-based model, of the group of refined trained AI-based models associated with the distributed node 402, for performance of operations of the distributed node 402 (e.g., the model selector component 410 can determine that model reselection does not have to be initiated). At this point, the distributed node 402, including the data collector component 406 and/or the first refined trained AI-based model, can continue to monitor the respective conditions associated with the distributed node 402.

If, instead, the model selector component 410 determines that there is a configuration update that relates to the first refined trained AI-based model, the model selector component 410 can perform various operations, which can include initiating a model reselection evaluation and determination, to facilitate determining whether there is to be a transition from the distributed node 402 utilizing the first refined trained AI-based model to utilizing the second refined trained AI-based model of the model group associated with the distributed node 402, such as described herein.

In some embodiments, with further regard to the threshold amount of change, if, instead, based at least in part on the results of comparing the respective conditions to the applicable threshold amount of change, or based at least in part on the enhancement quality indicator, the model selector component 410 determines that the threshold amount of change in the respective conditions associated with the distributed node has occurred or has been detected, the model selector component 410 can perform various operations, which can include initiating a model reselection evaluation and determination, to facilitate determining whether there is to be a transition from the distributed node 402 utilizing the first refined trained AI-based model to utilizing the second refined trained AI-based model of the model group associated with the distributed node 402.

In certain embodiments, in accordance with the state machine and corresponding model selection process, based at least in part on determining that the threshold amount of change in the respective conditions associated with the distributed node 402 has occurred, or based at least in part on determining that there is a configuration update that relates to the first refined trained AI-based model, the distributed node 402, employing the data processor component 408 and/or the model selector component 410 (and/or another component of the distributed node 402), can analyze a group of condition-related information items relating to respective conditions associated with the group (e.g., cluster) of distributed nodes and/or relating particularly to the distributed node 402. The group of condition-related information can comprise, for example, a first subgroup of condition-related information items relating to respective conditions associated with the group of distributed nodes, comprising the distributed node 402, and/or a second subgroup of condition-related information items relating particularly to the distributed node 402.

Based at least in part on the results of analyzing the group of condition-related information items, the data processor component 408 and/or the model selector component 410 (and/or another component of the distributed node 402) can determine (e.g., compute or otherwise determine) statistical data relating to (e.g., representative of) the group of condition-related information items. In some embodiments, the statistical data and/or the group of condition-related information items, or a portion thereof, may have been utilized to facilitate training and validation of the group of refined trained AI-based models associated with the distributed node 402 and/or or another group of trained AI-based models associated with the group of distributed nodes, wherein such other group of trained AI-based models can comprise the group of refined trained AI-based models associated with the distributed node 402.

In certain embodiments, in accordance with the state machine and corresponding model selection process, the model selector component 410 can compare (e.g., evaluate) the statistical data to respective items of metadata associated with the respective refined trained AI-based models of the group of refined trained AI-based models associated with the distributed node 402. In some embodiments, the respective items of metadata can indicate which of the respective refined trained AI-based models can be utilized (e.g., can be the most suitable, enhanced, or optimal) by the distributed node 402 under the respective conditions associated with the distributed node 402. In certain embodiments, the respective items of metadata can comprise the respective artifacts that can comprise respective model selection criterion, which can correspond to respective performance enhancement (e.g., optimization) goals to facilitate determination and selection of a desirable (e.g., most suitable, enhanced, or optimal) refined trained AI-based model from the group of refined trained AI-based models associated with the distributed node 402 by the model selector component 410, such as described herein. In some embodiments, the model selector component 410 also can analyze (e.g., evaluate) one or more respective independent input variables (e.g., relating to one or more certain conditions), one or more respective dependent input variables (e.g., relating to one or more certain other conditions), respective dependent performance outcome information items, respective model performance or validation information items, and/or respective goal-related information items that can indicate or specify one or more performance goals (e.g., performance enhancement goals, such as model, distributed node, and/or network level performance enhancement goals) associated with model selection.

In some embodiments, from the group of refined trained AI-based models associated with the distributed node 402, the model selector component 410 can determine (e.g., in real time or near real time) the desirable (e.g., the most suitable, enhanced, or optimal) refined trained AI-based model (e.g., 422), which can be utilized to perform the desired operations (e.g., inference and/or other AI-based operations) of the distributed node 402, based at least in part on the result (e.g., comparison result) of comparing the statistical data to the respective items of metadata associated with the respective refined trained AI-based models, and/or based at least in part on the results of analyzing the one or more respective independent input variables, the one or more respective dependent input variables, the respective dependent performance outcome information items, the respective model performance or validation information items, and/or the respective goal-related information items, in accordance with the defined model selection criteria, which can comprise distributed node and/or model performance enhancement (e.g., optimization) criteria (e.g., specifications). For instance, from the group of refined trained AI-based models associated with the distributed node 402, the model selector component 410 can determine which model of the respective refined trained AI-based models can be the best fit (e.g., can be most suitable, enhanced, or optimal) for use by the distributed node 402, given the conditions associated with the distributed node 402 and the applicable performance enhancement goals associated with the distributed node 402.

With further regard to the respective items of metadata, in some embodiments, the first refined trained AI-based model can have a first group of respective items of metadata that can relate to, indicate, or correspond to a first group of performance enhancement goals, the second refined trained AI-based model can have a second group of respective items of metadata that can relate to, indicate, or correspond to a second group of performance enhancement goals, and other respective trained AI-based models of the model group can have other respective groups of respective items of metadata that can relate to, indicate, or correspond to other respective groups of performance enhancement goals. In some embodiments, the model selector component 410 can determine which model of the respective refined trained AI-based models of the model group can be the best fit (e.g., can be most suitable, enhanced, or optimal) for use by the distributed node 402 based at least in part on the results of evaluating the configured performance enhancement parameters of the configuration of the distributed node 402, the respective groups of respective items of metadata associated with the respective refined trained AI-based models, and the respective conditions associated with the distributed node 402 in relation to each other, wherein the configured performance enhancement parameters can correspond to and/or can be representative of the desired performance enhancement goals for the distributed node 402, in accordance with the defined model selection criteria. For example, the model selector component 410 can determine which refined trained AI-based model of the respective refined trained AI-based models of the model group can best satisfy and/or achieve the desired performance goals associated with the distributed node 402 under the conditions associated with the distributed node 402, based at least in part on the results of evaluating the configured performance enhancement parameters of the configuration of the distributed node 402, the respective groups of respective items of metadata associated with the respective refined trained AI-based models, the respective conditions associated with the distributed node 402 in relation to each other, and/or the analysis results relating to the one or more respective independent input variables, the one or more respective dependent input variables, the respective dependent performance outcome information items, the respective model performance or validation information items, and/or the respective goal-related information items.

In certain embodiments, in accordance with the state machine and corresponding model selection process, the model selector component 410 can determine whether the first (e.g., the current or instantiated) refined trained AI-based model is the desirable refined trained AI-based model to utilize to perform the desired operations of the distributed node 402. If the model selector component 410 determines that the first refined trained AI-based model is the desirable refined trained AI-based model, the model selector component 410 can determine that the first refined trained AI-based model can continue to be utilized by the distributed node 402 to perform desired operations for the distributed node 402. In response to determining that the first refined trained AI-based model is the desirable refined trained AI-based model that is to continue to be utilized, the model selector component 410 can determine that there is to be no transition (e.g., model reselection) to another refined AI-based model, at least at this time.

In some embodiments, in accordance with the state machine and corresponding model selection process, in response to determining that the first refined trained AI-based model is to continue to be utilized, the model selector component 410 can initiate (e.g., start or trigger) and/or set a timer for a defined time period to enable additional condition-related information relating to the conditions associated with the distributed node 402 to be obtained (e.g., by the data collector component 406 and/or other component) and/or analyzed (e.g., by the data processor component 408, the model selector component 410, and/or another component). At this point, monitoring and analysis of the respective conditions associated with the distributed node 402 can continue to be performed.

In certain embodiments, in accordance with the state machine and corresponding model selection process, if, instead, the model selector component 410 determines that the first refined trained AI-based model is not the desirable trained AI-based model, and determines that another (e.g., the second) refined trained AI-based model is the desirable (e.g., the most suitable, enhanced, or optimal) trained AI-based model, the model selector component 410 can transition (e.g., switch) or facilitate transition of the distributed node 402 from utilizing the first refined trained AI-based model to utilizing the second refined trained AI-based model for performance of desired AI-based operations of the distributed node 402. Accordingly, after such transition, the distributed node 402 can begin to utilize the second refined trained AI-based model for performance of desired AI-based operations of the distributed node 402. A selected and instantiated refined trained AI-based model can run on-node (e.g., on the distributed node 402) to perform desired operations as a means of enhancing on-node performance of the distributed node 402.

At this point, monitoring and analysis of the respective conditions associated with the distributed node 402 can continue to be performed. For instance, the data processor component 408 can continue to monitor, analyze, and/or determine conditions and/or the characteristics associated with the distributed node 402 and/or the devices at desired times. The model selector component 410 can continue to determine, select, and/or instantiate desirable (e.g., most suitable or optimal) refined trained AI-based models at the desired times, based at least in part on the respective conditions and/or the respective characteristics associated with the distributed node 402 and/or the devices at the respective desired times, in accordance with the defined model management criteria (e.g., the defined model selection criteria of the defined model management criteria). For example, the model selector component 410, the data processor component 408, the data collector component 406, and/or other components can continue to perform their respective functions and operations to monitor respective conditions associated with the distributed node 402 and analyze the condition-related information and/or other data to facilitate determining whether the transition to a particular (e.g., second or other) refined trained AI-based model is enhancing performance of the distributed node 402, including the performance of AI-based operations, and/or to facilitate determining whether there is a change in conditions (e.g., threshold change in conditions) or a configuration update associated with the distributed node 402 that can trigger a model reselection evaluation and determination to be performed by the model selector component 410, in accordance with the state machine and corresponding model selection process, and in accordance with the defined model management criteria.

In some embodiments, there can be desirable orchestration of transitioning from one refined trained AI-based model to another refined trained AI-based model (e.g., another model variant) such that initiation, triggering, and running of a refined trained AI-based model can be desirably coordinated at each distributed node. For instance, in connection with transitioning from one refined trained AI-based model to another refined trained AI-based model, the model selector component 410 and/or other components of the distributed node 402 can perform the triggering of such transition from one model to the other model, can synchronize such transition from one model to the other model, and can manage the operation (e.g., running) of the other model on the distributed node 402 such that network and operational performance, including mission-mode operational performance and/or other low latency operational performance, of the distributed node 402 can continue to be maintained without undesirable (e.g., unwanted and/or negative) disruption or impact.

In certain embodiments, to facilitate performing the model selection process, including the model reselection evaluations and determinations, the model selector component 410, the model manager node 116, and/or another component(s) can apply respective weight values and/or normalization factors (e.g., normalization factor values) to respective data items (e.g., respective condition values, respective performance enhancement parameters associated with respective performance enhancement criterions, and/or other data items) to facilitate desired evaluation of such data items. For example, if there are multiple performance enhancement parameters relating to multiple performance enhancement goals desired to be achieved for a configuration associated with the distributed node 402, the model selector component 410, the model manager node 116, and/or another component(s) can apply a first (e.g., higher) weight value to a first performance enhancement parameter associated with a first condition (e.g., QoS, latency, or throughput) and a second (e.g., relatively lower) weight value to a second performance enhancement parameter associated with a second condition (e.g., energy consumption efficiency), if the first performance enhancement parameter is considered to be more significant (e.g., more important or higher priority) than the second performance enhancement parameter, in accordance with the desired configuration. As another example, the model selector component 410, the model manager node 116, and/or another component(s) can apply respective (e.g., different or unique) normalization factor values to respective data values of respective data items associated with respective conditions such that the respective data values can be normalized to facilitate desirable (e.g., suitable, useful, or optimal) evaluation or comparison of the respective data values (e.g., the respective normalized data values).

In certain embodiments, there may be an instance where a refined trained AI-based model associated with another distributed node (e.g., 112), and stored in the model repository 118, can be desirable (e.g., suitable or optimal) for use by the distributed node 402 based at least in part on particular conditions and/or characteristics associated with the distributed node 402 and/or associated devices at a particular time period, where, for example, the distributed node 402 may not yet have a refined trained AI-based model that is as desirable under those particular conditions and/or characteristics. In such an instance, the model selector component 410 can determine that the refined trained AI-based model associated with the other distributed node can be selected for use by the distributed node 402, and the model selector component 410 can access and/or retrieve the desired refined trained AI-based model from the model repository 118 of the central node 108 for use by the distributed node 402.

In certain other instances, a refined trained AI-based model associated with another distributed node (e.g., 112), and stored in the model repository 118, can relate to certain conditions and/or certain characteristics that can be similar to some conditions and/or some characteristics that can be associated with the distributed node 402 at certain times, wherein, for example, the distributed node 402 may not yet have a refined trained AI-based model that can be desirable under those certain conditions and/or certain characteristics. In some embodiments, instead of the distributed training node 404 performing second stage (e.g., node-specific) model training on a first stage trained AI-based model to generate a refined trained AI-based model relating to those certain conditions and/or certain characteristics, the distributed training node 404 performing node-specific (e.g., third stage) model training on the refined trained AI-based model associated with the other distributed node to generate a refined trained AI-based model usable by the distributed node 402 under those certain conditions and/or certain characteristics, in accordance with the defined model management criteria. In such instance, the distributed training node 404 may utilize fewer iterations, processing, and/or resources in adapting the refined trained AI-based model associated with the other distributed node to generate the refined trained AI-based model usable by the distributed node 402 under those certain conditions and/or certain characteristics than the distributed training node 404 may otherwise have used to perform second stage model training on the first stage trained AI-based model to generate a similar refined trained AI-based model for use under those certain conditions and/or certain characteristics.

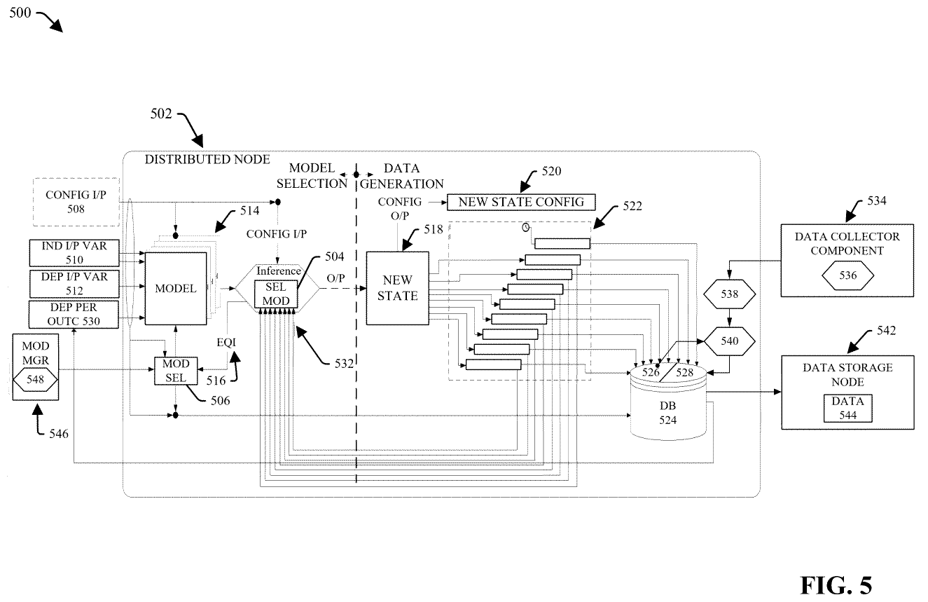

Referring to FIG. 5 (along with FIGS. 1-4), FIG. 5 illustrates a diagram of a non-limiting example data and process flow 500 for data generation and model selection, in accordance with various aspects and embodiments of the disclosed subject matter. In some embodiments, in accordance with the example data and process flow 500, with regard to a distributed node 502 (e.g., an AI/ML-enabled distributed node), there can be a selected model (SEL MOD) 504 (e.g., selected refined trained AI-based model), as selected by the model selector component (MOD SEL) 506, in accordance with the model selection process and the defined model selection criteria. The selected model 504 can be performing inference and other desired AI-based operations for the distributed node 502. In some embodiments, the selected model 504 can be receiving configuration input data (CONFIG I/P) relating to performance enhancement (e.g., optimization) parameters associated with the distributed node 502 and the selected model 504, as indicated at reference numeral 508. For example, the configuration input data (e.g., configured performance enhancement parameters and/or other configuration input data) can relate to a configuration that can be enhanced (e.g., optimized) for energy efficiency, distortion, channel conditions, throughput, latency, QoS, and/or another desired condition. As indicated at reference numerals 510 and 512, respectively, the selected model 504 and/or other models 514 (e.g., other refined trained AI-based models of the group of refined trained AI-based models associated with the distributed node 502) can be receiving independent input variables (IND I/P VAR) and dependent input variables (DEP I/P VAR). For example, the selected model 504 and/or other models 514 can be receiving information relating to traffic load, ambient temperature, and/or another desired condition as independent input variables, and/or can be receiving information relating to CQI and/or another desired condition as dependent input variables.

In certain embodiments, the selected model 504 can be providing an enhancement quality indicator (EQI) 516 to the model selector component 506 to facilitate indicating, to the model selector component 506, whether the performance of the selected model 504 and/or the distributed node 502 overall is desirable or is instead degraded, in accordance with the defined model selection criteria. In some embodiments, the selected model 504 also can be generating output result data (O/P), including data relating to a state of the distributed node 502, wherein the output data relating to the state of the distributed node 502 can be provided to determine and/or select a new state 518 of the distributed node 502, as part of the data generation flow.

In certain embodiments, the data processor component (e.g., 408) or other component of the distributed node 502 can determine new state configurations NEW STATE CONFIG) 520 based at least in part on the configuration outputs (CONFIG O/P) determined or derived based at least in part on the new state 518 associated with the distributed node 502. In some embodiments, as part of the data generation flow, the data collector component (e.g., 406) or other component of the distributed node 502 can monitor, read, and/or record various desired conditions 522 associated with the distributed node 502. The desired conditions 522 can comprise, for example, distortion, energy consumption, emissions, Vbias, component temperature, RF_Pout, CFR coefficients, DPD coefficients, and/or other conditions, such as described herein, over and based at least in part on various desired time periods (e.g., time of data, day of week, month of year, or other desired time period(s)). Respective condition-related data items relating to the respective conditions 522 and operational performance can be communicated to and stored in a database 524 of the data store (e.g., 414) of the distributed node 502. In accordance with various embodiments, the database 524 also can store previous (e.g., historical) respective condition-related data items relating to the respective conditions and the statistical data relating to (e.g., representative of and/or derived from) current or previous respective conditions associated with the distributed node 502 and/or other distributed nodes of the group (e.g., cluster) of distributed nodes. In some embodiments, the information stored in the database 524 can comprise the accumulation of data before and after state changes associated with the distributed node 502.

In certain embodiments, the database 524 can comprise a node-specific database 526 that can store node-specific information (e.g., the respective condition-related data items, and/or other data) relating in particular to the distributed node 502 and a data collector (e.g., data collector management) database 528 that can store processed (e.g., refined, derived, calculated, filtered, selected, or otherwise processed) node-related information (e.g., the statistical data, respective processed condition-related data items, and/or other data) that can relate to at least the distributed node 502. The node-specific information can comprise, for example, the state information, the statistical data, the independent input variables, the dependent input variables, the configuration input data relating to the performance enhancement goals, other condition-related information, dependent performance outcome information (DEP PER OUTC) 530 relating to performance of the selected model 504 and/or previous selected models, model selector data, and/or other node-specific information. The dependent performance outcome information 530 can comprise, for example, statistical data relating to or indicating the performance of (e.g., the performance level, characteristics, parameter values, and/or other performance-related details regarding) the selected model 504 and/or previous selected models and/or the distributed node 502 overall, and can indicate the impact of changes resulting from the selection of a model (e.g., selection of the selected model 504 and transition from the previous selection model to the selected model 504), changes resulting from modification of the configuration of the distributed node 502, and/or other changes associated with the distributed node 502. In certain embodiments, the dependent performance outcome information 530 can be fed (e.g., communicated) back as input data into the selected model 504, the other models of the model group, and/or the model selector component 506 for analysis and/or AI-based operations. In some embodiments, in addition to the respective condition-related data items relating to the respective conditions 522 being stored in the database 524, information relating to operational performance can be fed (e.g., communicated) back and input to the selected model 504 for analysis by the selected model 504, as indicated at reference numeral 532.

With further regard to the data collector (e.g., data collector management) database 528, in certain embodiments, the data collector database 528 can store at least some (e.g., selected) of the previous respective condition-related data items relating to the respective conditions, the statistical data relating to (e.g., representative of and/or derived from) current or previous respective conditions associated with the group (e.g., cluster) of distributed nodes, training datasets, and/or other processed or refined information relating to the distributed node 502. It is noted that, in some embodiments, the training datasets may comprise node-specific information relating to the distributed node 502 and/or some multi-node information relating to the group of distributed nodes. In certain embodiments, the data collector component 534 of the distributed node 502 can employ a data collection enhancement function 536 that can desirably collect, select, and/or process (e.g., pre-process) respective data items, including respective condition-related data items, of or associated with the distributed node 502, such as described herein. In some embodiments, the data collector component 534 can employ a node management function 538 and a node data selection function 540 to facilitate determining and selecting the desired information (e.g., desired subset of information items) relating to the distributed node 502 that can be stored in the data collector database 528 for use and analysis by the distributed node 502, including the model selector component 506 and the selected model 504. For instance, the node data selection function 540 can be utilized to select desired information (e.g., a certain subset of the condition-related data items and/or a subset of other distributed node-related information) determined to be relevant and/or otherwise desirable (e.g., suitable, useful, wanted, or optimal) for use in generation of training datasets for multi-node model training and/or node-specific model training, in accordance with the defined model management criteria.

In some embodiments, the distributed node 502 also can communicate data stored in the database 524 to a data storage node 542 that can be off-node (e.g., the data store 308 of the central node 108, or other off-node data store) to store such data off-node. The data 544 transferred to and stored in the data storage node 542 can comprise, for example, raw data (e.g., raw data relating to conditions associated with the distributed node 502), the statistical data relating to the distributed node 502, and/or other desired information relating to the distributed node 502.

In certain embodiments, in addition to all of the other information that can be input to the model selector component 506, the model selector component 506 can receive, as input, information from the model manager node (MOD MGR) 546 to facilitate desirable performance of model selection process by the model selector component 506. For instance, the model manager node 546, employing its model management functions 548, can communicate, to the model selector component 506, information relating to the state machine, respective metadata items (e.g., including the respective artifacts) associated with the respective refined trained AI-based models associated with the distributed node 502, configuration data, model management/selection criteria, performance enhancement goal information, and/or other desired information, such as described herein.

The disclosed subject matter, by employing the model selector component 506, the other components, and the example data and process flow 500 for data generation and model selection, can desirably perform the model selection process to select/reselect refined trained AI-based models for use in performing inference and other AI-based operations for and on the distributed node 502, in accordance with the model selection process and the state machine, and in accordance with the defined model management/selection criteria, such as described herein.

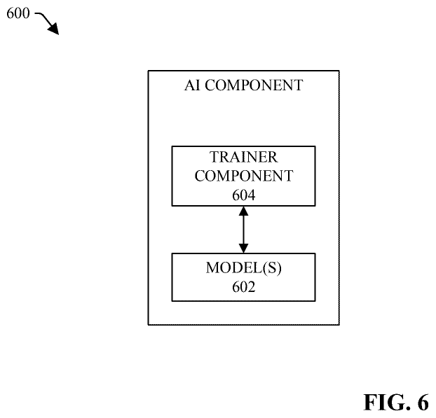

Referring to FIG. 6 (along with FIGS. 1-4), FIG. 6 depicts a diagram of a non-limiting example AI component 600, in accordance with various aspects and embodiments of the disclosed subject matter. In accordance with various embodiments, the central training node 114 or a distributed training node (e.g., 120 (or 402) or 122) can be or can comprise an AI component, such as the AI component 600. In some embodiments, the AI component 600 and/or a model 602 (e.g., AI-based model) can perform an AI-based analysis on data, such as information relating to communication sessions, data traffic, applications, services, attributes, conditions, characteristics, operations, functions, parameters, events, and/or other features associated with the RAN and/or devices (e.g., device 104 and/or device 106), and/or the core network 204, and/or feedback information (e.g., feedback information from a user, a device, a base station, network equipment or network function of the core network 204, or another data source). In some embodiments, with regard to a model 602, the AI component 600 can input such information into the (trained) model 602 for analysis (e.g., AI-based analysis) by the model 602 to train or update the model 602 or to generate AI-based output result data based at least in part on the analysis of the input information.

In connection with or as part of such an AI-based analysis, the AI component 600 can employ, build (e.g., construct or create), and/or import, AI-based techniques and algorithms, AI-based models 602 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about patterns of communication of data associated with applications, services, and/or devices, determining or learning about patterns of conditions and/or characteristics associated with a distributed node, determining or learning about patterns of respective conditions and/or respective characteristics associated with a group of distributed nodes, determining or learning about similarities or differences between respective conditions and/or respective characteristics associated with respective distributed nodes, determining or learning about data traffic associated with communication sessions between the RAN and devices (e.g., 104 and/or 106), performing other desired functions or operations, and/or automating one or more functions or features of the disclosed subject matter, as more fully described herein.

The AI component 600 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 600 can examine the entirety or a subset of the data (e.g., the training data; the operational data relating to the communication network 102, the core network 204, a device (e.g., device 104 and/or device 106), the RAN, a base station, one or more distributed nodes, and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 600 and/or the trained model(s) 602 can employ one or more threshold probabilities (e.g., threshold probability values) to facilitate making a determination. For instance, in making a determination (e.g., a determination of whether a desired QoS associated with a device associated with a distributed node can be satisfied under certain conditions associated with the distributed node and/or the device, or other determination), as part of the AI-based analysis of information, the AI component 600 and/or the trained model(s) 602 can determine a probability (e.g., a probability that the desired QoS associated with the device can be satisfied under the certain conditions associated with the distributed node and/or the device, or other probability), and can determine whether the probability (e.g., probability value) satisfies (e.g., meets or exceeds; or is at or greater than) a defined and applicable threshold probability. The AI component 600 and/or the trained model(s) 602 can make a determination (or prediction or inference) (e.g., a determination (or prediction or inference) of whether to allocate more resources for the device to satisfy, or try to satisfy, the desired QoS associated with the device, or other determination) based at least in part on the results of analyzing (e.g., comparing) the probability to the defined and applicable threshold probability (e.g., threshold minimum probability value). As a non-limiting example, the AI component 600 and/or the trained model(s) 602 can make a determination (or prediction or inference) that allocating more resources for the device can satisfy the desired QoS associated with the device based at least in part on determining that a probability that allocating more resources for the device can satisfy the desired QoS associated with the device satisfies the defined and applicable threshold probability (e.g., the probability is the highest probability, relative to other probabilities relating to achieving the desired QoS associated with the device, and satisfies the defined and applicable threshold probability). In other embodiments, the AI component 600 and/or the trained model(s) 602 can make a determination (or prediction or inference) that allocating more resources for the device can satisfy the desired QoS associated with the device based at least in part on determining that a probability that allocating more resources for the device can satisfy the desired QoS associated with the device is a highest probability relative to the other probabilities, without use of and/or without regard to a threshold probability.

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 600 can employ a classifier that can perform an AI-based analysis on data. A classifier can map an input attribute vector, z=(z1,z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 600 (e.g., employing the trainer component 604) can comprise, generate, and/or train (e.g., iteratively train) AI-based models 602 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between components (e.g., RAN, cells, distributed nodes, network nodes, communication links, devices, or other components or functions) of or associated with the communication network 102; data traffic (e.g., type of data traffic, amount of data traffic, or other characteristic of data traffic) associated with communication sessions between the RAN and devices (e.g., device 104 and/or device 106, utilizing an application or service); patterns of communication of data associated with applications, services, and/or devices; patterns of conditions and/or characteristics associated with a distributed node; patterns of respective conditions and/or respective characteristics associated with a group of distributed nodes; similarities or differences between respective conditions and/or respective characteristics associated with respective distributed nodes; and/or patterns of data traffic associated with communication sessions between devices (e.g., 104 and/or 106) and a distributed node, a group of distributed nodes, and/or the RAN; and/or to perform other desired functions or operations, and/or to automate one or more functions or features of the disclosed subject matter, as described herein.

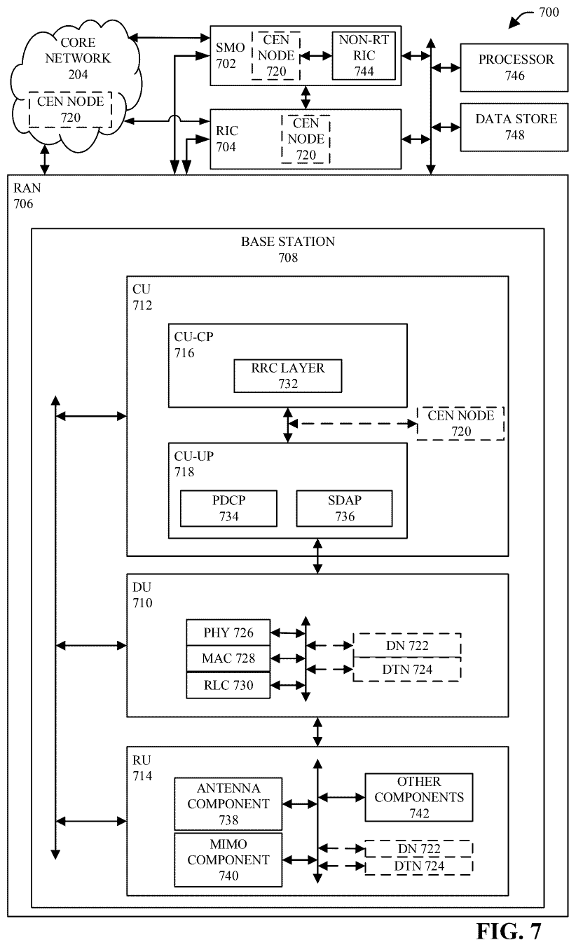

Turning to FIG. 7 (along with FIGS. 1 and 2), FIG. 7 depicts a block diagram of non-limiting example system 700 that can comprise the central node and the distributed training node(s) in the RAN in an O-RAN communication network environment to facilitate desirable (e.g., suitable, reliable, efficient, enhanced, and/or optimal) management and performance of multi-stage training (e.g., multi-node and node-specific training) of AI-based models and selection of desirable node-specific trained AI-based models that can be utilized by distributed nodes, in accordance with various aspects and embodiments of the disclosed subject matter. In some embodiments, the system 700 can be part of the system 100 depicted in FIG. 1 or the system 200 depicted in FIG. 2.

The system 700 can comprise an SMO 702, a RIC 704, and a RAN 706. In some embodiments, the RAN 706 can be an O-RAN that can be part of an O-RAN architecture and environment (e.g., the communication network 102 can employ an O-RAN architecture and environment). In certain embodiments, the RAN 706 can be deployed as a centralized or distributed RAN, and, in either of those cases, the RAN 706 can be instantiated on a cloud as a cloud-based RAN (C-RAN), or instantiated on a virtualized infrastructure as a virtual RAN (vRAN), wherein any of these scenarios and implementations may or may not be following O-RAN architecture and specifications. In still other embodiments, the RAN 706 may not be an O-RAN, C-RAN, or vRAN.

In accordance with various embodiments, the RAN 706 and associated communication network (e.g., communication network 102) can be part of a 5G or other communication environment (e.g., an xG communication environment, wherein x can be 5 or a number greater than 5). In some embodiments, with regard to 5G or other generation (e.g., xG), the RAN 706 can comprise base stations, such as a gNodeB (gNB), that can be disaggregated into a CU (e.g., gNB CU), comprising a CU-user plane (CU-UP) (e.g., gNB CU-UP), a CU-control plane (CU-CP) (e.g., gNB CU-CP), and a DU (e.g., gNB DU). In certain embodiments, the CU-UP and DU can perform various desired user plane functions, with the CU-UP hosting PDCP and SDAP functions, and the DU can host the RLC, MAC, and, optionally, at least part of the PHY layers. For instance, the RAN 706 can comprise the base station 708 that can comprise a DU 710, a CU 712, and an RU 714 (e.g., a gNB RU). The CU 712 can comprise a CU-CP 716 (also referred to as a CU-CP node) and a CU-UP 718 (also referred to as a CU-UP node). In certain embodiments, the RAN 706 and/or the base station 708 can comprise multiple DUs, multiple CU-CPs, multiple CU-UPs, and/or multiple RUs. In some embodiments, the DU 710, the CU 712, and the RU 714 can be co-located at a cell site. In other embodiments, the RAN 706 can be a disaggregated RAN where one or more of the components (e.g., the CU 712, or at least part of the CU 712, such as the CU-CP 716) of the base station 708 can be located in different location than one or more other components (e.g., DU 710, RU 714, and/or CU-UP 718) of the base station 708.

In accordance with various embodiments, the system 700 can comprise a central node 720 that can be associated with (e.g., communicatively connected to or part of) the SMO 702, the RIC 704, and/or the CU 712, and/or can otherwise be part of or associated with the RAN 706, wherein the central node 720 can comprise various functionality and features, such as described herein. In accordance with various embodiments, the system 700 can comprise one or more distributed nodes, such as distributed node 722 that can be associated with (e.g., communicatively connected to or part of) the RU 714 and/or the DU 710, and/or can otherwise be part of the RAN 706, wherein the one or more distributed nodes (e.g., distributed node 722) can comprise various functionality and features, such as described herein. In accordance with various embodiments, the system 700 also can comprise one or more distributed training nodes, such as distributed training node 724 that can be associated with (e.g., communicatively connected to or part of) the distributed node 722, the RU 714, the DU 710, and/or the CU 712, and/or can otherwise be part of the RAN 706 and/or the central node 720, wherein the one or more distributed training nodes (e.g., distributed training node 724) can comprise various functionality and features, such as described herein. As a non-limiting example, one or more distributed training nodes, such as the distributed training node 724, can be logical distributed training nodes that can be physically or deployment-wise within the CU 712 or CU host, and can be mapped to specific RUs (e.g., RU 714 and/or another RU(s)) and/or DUs (e.g., DU 710 and/or another DU(s)).

The DU 710 can be a logical node that can host or handle baseband (e.g., physical layer (PHY) 726 (e.g., layer 1 (L1))) and layer 2 (L2) (e.g., a medium access control (MAC) layer 728 and a radio link control (RLC) layer 730) functionality associated with the base station 708. The CU-CP 716 can be a logical node that can host or handle layer 3 (L3) (e.g., a radio resource control (RRC) layer 732) control plane functionality associated with the base station 708. The CU-UP 718 can be a logical node that can host or handle data traffic between the core network 204 (e.g., 5G core network) and one or more DUs (e.g., the DU 710) to which the CU-UP 718 is connected. In some embodiments, the CU-UP 718 can comprise a packet data convergence protocol (PDCP) component (PDCP) 734 that can perform PDCP functions, and a service data adaptation protocol (SDAP) component (SDAP) 736 that can perform SDAP functions. In certain embodiments, the PDCP protocol can be utilized as part of the RRC layer 732 to process signaling bearers.

The RU 714 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 706 and other devices (e.g., devices 104 and/or 106) or components (e.g., components or functions of the core network 204 or communication network 102). In certain embodiments, depending in part on the fronthaul split (e.g., the division of fronthaul-related functions) utilized, some higher PHY layer functions also can be included and employed in the RU 714. In some embodiments, the RU 714 can comprise an antenna component 738 that can comprise an antenna array that can comprise a desired number of transmitter and receiver antennas to facilitate transmission and receiving of signals comprising information, and perform various beamforming, antenna-related, and communication-related functions. The RU 714 also can comprise a MIMO component 740 that can be employed to generate or modify a number of MIMO spatial layers and a number of spatial streams employed by the base station 708 (e.g., with regard to a device(s)) during a communication session between the base station 708 and a device (e.g., device 104), and may perform MIMO spatial multiplexing functions. In certain embodiments, the MIMO component 740 can be configured in a single user (SU)-type MIMO mode or a multiple user (MU)-type MIMO mode. In some embodiments, the MIMO component 740 can employ or support massive MIMO (mMIMO). The RU 714 also can comprise or be associated with other components 742 that can utilize and/or perform various other RU and RF functions. Some other functions that can be employed by the antenna component 738, the MIMO component 740, and/or the other components 742 can include, for example, modulation and coding scheme (MCS) functions, transmit diversity functions, beamforming functions (e.g., utilized with MIMO functions), and/or other functions.

In some embodiments, as disclosed, the system 700 can comprise an O-RAN architecture and environment, and the RAN 706 can be an O-RAN. In some embodiments, in the O-RAN architecture and environment, the SMO component 702 can be associated with (e.g., communicatively connected to) the RIC 704 and/or the RAN 706 (and/or one or more other RANs) via an interface(s) (e.g., an O1 interface, an A1 interface, or another interface), to facilitate communication of information between the SMO component 702 and the RIC 704 and/or the RAN 706 (and/or one or more other RANs), and the RIC 704 can be associated with the RAN 706 (and/or one or more other RANs) via an interface(s) (e.g., an E2 interface or another interface), to facilitate communication of information between the RIC 704 and the RAN 706 (and/or one or more other RANs). In some embodiments, the SMO component 702 can comprise a non-real time RIC 744 (NON-RT RIC) that can perform some RAN intelligent controller functions in non-real time. In certain embodiments, the RIC 704 can be or can comprise a near real time RIC that can perform at least some of the various RAN intelligent controller functions in real time or at least near real time.

The SMO component 702 can act and operate as a management and orchestration layer that can control configuration and automation aspects of the RIC 704 and RAN elements of the RAN(s) 706. The SMO component 702 can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time.

The RIC 704 can operate to control (e.g., manage) and enhance (e.g., improve or optimize) RAN functions and services of the RAN(s) 706. As disclosed, at least some of the various network functions and components of the RIC 704 can operate in real time or near real time, whereas certain other network functions and components of the non-real time RIC 744 may operate in non-real time.

In accordance with various embodiments, the system 700 can comprise a processor component 746 that can be associated with (e.g., communicatively connected to) and can work in conjunction with other components of the system 700, including the SMO component 702, the RIC 704, the RAN 706, the central node 720, the distributed node 722, the distributed training node 724, a data store 748, and/or other components of the system 700, to facilitate performing the various functions and operations of the system 700. The processor component 746 can employ one or more processors (e.g., one or more central processing units (CPUs)), accelerators, graphics processing units (GPUs), application-specific integrated circuits (ASICs), microprocessors, controllers, microcontrollers, or other processors) that can process information relating to data, files, services, applications, RANs, base stations, cells, communication network, core network, devices, users, data traffic, communication sessions (e.g., PDU or other communication sessions), uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information, to facilitate operation of the system 700, and control data flow between the system 700 and/or other components (e.g., network equipment, components, or functions, the communication network 102, the core network 204, another base station, a device (e.g., 104 or 106), a node, an application, a service, a user, or other entity) associated with the system 700.

The data store 748 can store data structures (e.g., user data, metadata), code structure(s) (e.g., modules, objects, hashes, classes, procedures) or instructions, information relating to data, files, services, applications, RANs, base stations, cells, communication network, core network, devices, users, data traffic, communication sessions, uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information, to facilitate controlling or performing operations associated with the system 700. The data store 748 can comprise volatile and/or non-volatile memory, such as described herein. In an aspect, the processor component 746 can be functionally coupled (e.g., through a memory bus) to the data store 748 in order to store and retrieve information desired to operate and/or confer functionality, at least in part, to the SMO component 702, the RIC 704, the RAN 706, the central node 720, the distributed node 722, the distributed training node 724, the processor component 746, the data store 748, and/or other component of the system 700, and/or substantially any other operational aspects of system 700.

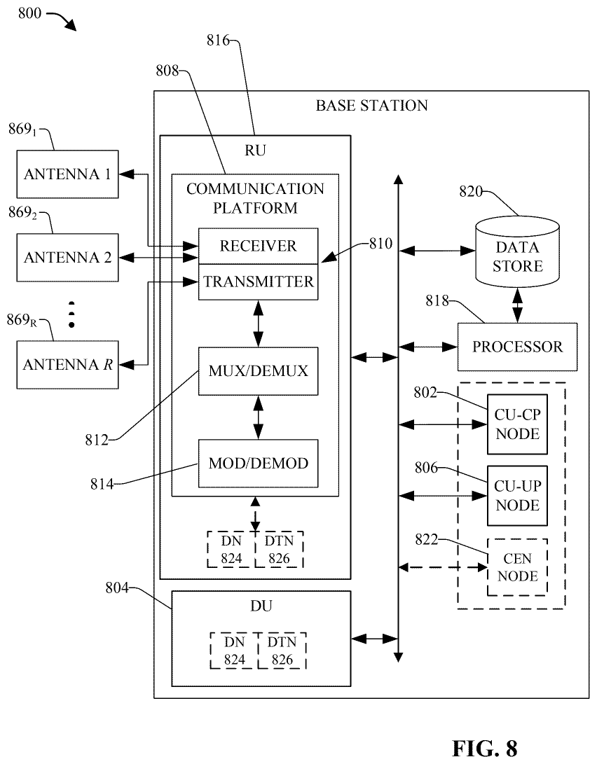

Turning to FIG. 8, FIG. 8 depicts a diagram of a non-limiting example base station 800 that can desirably facilitate (e.g., enable) connections (e.g., wireless connections) and communication of information associated with devices, in accordance with various aspects and embodiments of the disclosed subject matter. In some embodiments, the base station 800 can be a 5G or other radio base station (e.g., gNB or xG base station, wherein x can be a number greater than 5). In other embodiments, the base station 800 can be a 4G or LTE base station, can be a base station that can comprise 5G or other xG functionality and 4G/LTE functionality, or can be some other type of base station (e.g., other type of access point).

With regard to a 5G or other radio base station, the base station 800 can comprise a CU-CP node 802 (e.g., a gNB CU-CP node), one or more DUs (e.g., a gNB DUs), including DU 804, a desired number of CU-UP nodes (e.g., a gNB CU-UP nodes), including CU-UP node 806, and/or other network equipment. The CU-CP node 802 can be associated or interfaced with the DUs (e.g., DU 804) via an interface (e.g., F1-C interface) or connection. The CU-CP node 802 can be associated, or interfaced, with the CU-UP nodes (e.g., CU-UP node 806) via an interface (e.g., E1 interface) or connection. The one or more CU-UP nodes (e.g., CU-UP node 806) can be associated or interfaced with the one or more DUs (e.g., DU 804) via an interface (e.g., F1-U interface) or connection.

A DU (e.g., DU 804) can provide support for lower layers of a protocol stack. For instance, a DU (e.g., DU 804) can be a logical node that can host or handle baseband (e.g., PHY) and L2 (e.g., MAC and RLC layer) functionality associated with the base station 800. A CU-UP node (e.g., CU-UP node 806) can be a logical node that can host or handle data traffic between the core network 204 (e.g., 5G or xG core network) and the DU(s) (e.g., DU 804) to which the particular CU-UP is connected. The CU-CP node 802 can be a logical node that can host or handle L3 (e.g., RRC and PDCP layer) control plane functionality associated with the base station 800.

In some embodiments, a device(s) (e.g., device(s) 110 and/or 112) can be connected to the base station 800, via the DU 804, wherein the CU-UP node 806 and the DU 804 can be serving the device by performing or facilitating performing downlink data transfers of downlink data to the device from a data source (e.g., a service and/or another device, or a network component of the communication network 102 or core network 204 (e.g., via the UPF node)), and uplink data transfers of uplink data from the device to a desired destination (e.g., the data source) via the base station 800.

The base station 800 can receive and transmit signal(s) from and to wireless devices like access points (e.g., base stations, femtocells, picocells, or other type of access point), access terminals (e.g., UEs), wireless ports and routers, and the like, through a set of antennas 869₁-869_{R}. In an aspect, the antennas 869₁-869_{R} can be a part of a communication platform 808, which comprises electronic components and associated circuitry that can provide for processing and manipulation of received signal(s) and signal(s) to be transmitted. In an aspect, the communication platform 808 can include a receiver/transmitter 810 that can convert signal from analog to digital upon reception, and from digital to analog upon transmission. In addition, receiver/transmitter 810 can divide a single data stream into multiple, parallel data streams, or perform the reciprocal operation.

In an aspect, coupled to receiver/transmitter 810 can be a multiplexer/demultiplexer (mux/demux) 812 that can facilitate manipulation of signal in time and frequency space. The mux/demux 812 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 812 can scramble and spread information (e.g., codes) according to substantially any code known in the art, e.g., Hadamard-Walsh codes, Baker codes, Kasami codes, polyphase codes, and so on. A modulator/demodulator (mod/demod) 814 also can be part of the communication platform 808, and can modulate information according to multiple modulation techniques, such as frequency modulation, amplitude modulation (e.g., M-ary quadrature amplitude modulation (QAM), with M a positive integer), phase-shift keying (PSK), and the like. In accordance with various embodiments, the communication platform 808 can be, can comprise, or can be associated with an RU 816 (e.g., a gNB RU node).

The base station 800 also can comprise a processor(s) 818 that can be configured to confer and/or facilitate providing functionality, at least partially, to substantially any electronic component in or associated with the base station 800. For instance, the processor(s) 818 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 800 can include a data store 820 that can store data structures; code instructions; rate coding information; information relating to measurement of radio link quality or reception of information related thereto; information relating to devices, communication conditions or performance indicators associated with devices (e.g., SINR, RSRP, RSRQ, CQI, QoS, perceived QoS, QoE, and/or other wireless communications metrics or parameters) associated with devices; information relating to data, files, services, applications, RANs, cells, communication network, core network, devices, users, data traffic, communication sessions, uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold values, weight values, data processing operations, messages, notifications, alarms, alerts, preferences, hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on.

The processor(s) 818 can employ one or more processors (e.g., one or more CPUs, accelerators, GPUs, ASICs, or other processors), microprocessors, or controllers) that can process information, and can be coupled to the data store 820 in order to store and retrieve at least some of the information (e.g., information, such as algorithms, relating to multiplexing/demultiplexing or modulation/demodulation; information relating to radio link levels; information relating to data, files, services, applications, RANs, cells, communication network, core network, devices, users, data traffic, communication sessions, uplink grants and allocations, condition or measurement reports, conditions, characteristics, the central node, the distributed node(s), the distributed training node(s), AI-based models, multi-node training, node-specific training, AI-related data, training data, feedback information, predictions, inferences, threshold values, weight values, data processing operations, messages, notifications, alarms, alerts, preferences, hash values, metadata, parameters, hyperparameters, traffic flows, tables, mappings, policies, the defined model management criteria, algorithms (e.g., enhanced model management algorithms, AI algorithms, hash algorithms, data compression algorithms, data decompression algorithms, and/or other algorithm), interfaces, protocols, tools, and/or other information) desired to operate and/or confer functionality to the communication platform 808 and/or other operational components of the base station 800. The data store 820 can comprise volatile memory and/or nonvolatile memory, such as described herein.

In accordance with various embodiments, the base station 800 can comprise a central node 822 that can be part of or can be associated with (e.g., can be deployed and/or instantiated on the same physical or logical computing infrastructure as or of) the CU (e.g., CU comprising CU-CP node 802 and CU-UP node 806) and/or other components of the RAN, and/or can otherwise be part of or associated with the base station 800, wherein the central node 822 can comprise various functionality and features, such as described herein. In accordance with various embodiments, the base station 800 also can comprise a distributed node 824 and a distributed training node 826 that can be part of or can be associated with the RU 816, the DU 804, and/or other components of the base station 800, and/or can otherwise be part of or associated with the base station 800, wherein the distributed node 824 and the distributed training node 826 can respectively comprise various functionality and features, such as described herein.

With further regard to the data stores and memory disclosed herein, the data store (e.g., 748 or 820) or memory can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects is intended to comprise, without being limited to, these and other suitable types of memory.

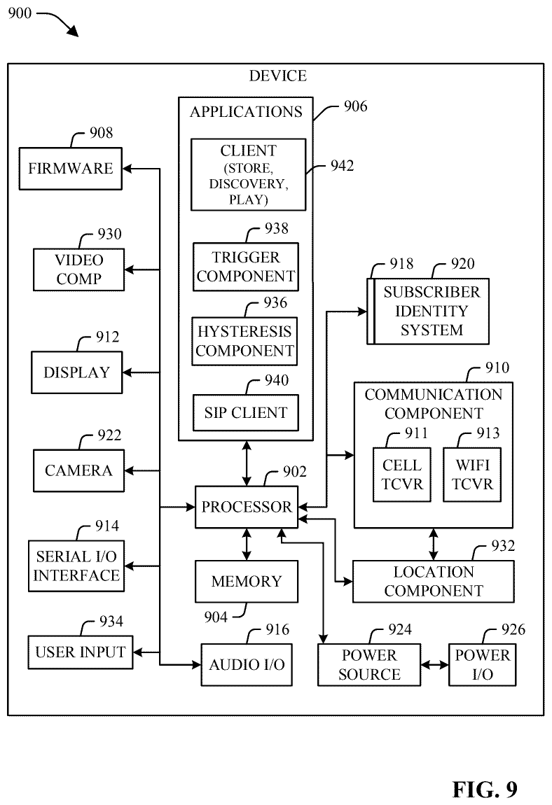

Referring to FIG. 9, FIG. 9 illustrates a diagram of a non-limiting example device 900 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 900 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 900, can typically include a variety of machine-readable media. Machine-readable media can be any available media that can be accessed by the computer and include both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 900 can include a processor(s) 902 for controlling and processing all onboard operations and functions. The processor(s) 902 can comprise one or more processors (e.g., one or more CPUs, accelerators, GPUs, ASICs, or other processors), microprocessors, or controllers) that can process information associated with the device 900. A memory 904 can interface to the processor(s) 902 for storage of data and one or more applications 906 (e.g., a video player software, user feedback component software, or other application). Other applications can include voice recognition of predetermined voice commands that facilitate initiation of the user feedback signals. Still other applications can comprise an AI application. The applications 906 can be stored in the memory 904 and/or in a firmware 908, and executed by the processor(s) 902 from either or both the memory 904 and/or the firmware 908. The firmware 908 can also store startup code for execution in initializing the device 900. A communication component 910 interfaces to the processor(s) 902 to facilitate wired/wireless communication with external systems, e.g., cellular networks, VoIP networks, and so on. Here, the communication component 910 can also include a suitable cellular transceiver 911 (e.g., a global system for mobile communication (GSM), orthogonal frequency division multiple access (OFDMA), 4G, LTE, 5G, other xG, or other type of transceiver) and/or an unlicensed transceiver 913 (e.g., Wi-Fi, WiMax) for corresponding signal communications. The device 900 can be a device such as a cellular telephone, a PDA with mobile communications capabilities, and messaging-centric devices. The communication component 910 also facilitates communications reception from terrestrial radio networks (e.g., broadcast), digital satellite radio networks, and Internet-based radio services networks.

The device 900 includes a display 912 for displaying text, images, video, telephony functions (e.g., a Caller ID function), setup functions, and for user input. For example, the display 912 can also be referred to as a “screen” that can accommodate the presentation of multimedia content (e.g., music metadata, messages, wallpaper, graphics, etc.). The display 912 can also display videos and can facilitate the generation, editing and sharing of video quotes. A serial I/O interface 914 is provided in communication with the processor(s) 902 to facilitate wired and/or wireless serial communications (e.g., USB, and/or IEEE 1394) through a hardwire connection, and other serial input devices (e.g., a keyboard, keypad, and mouse). This supports updating and troubleshooting the device 900, for example. Audio capabilities are provided with an audio I/O component 916, which can include a speaker for the output of audio signals related to, for example, indication that the user pressed the proper key or key combination to initiate the user feedback signal. The audio I/O component 916 also facilitates the input of audio signals through a microphone to record data and/or telephony voice data, and for inputting voice signals for telephone conversations.

The device 900 can include a slot interface 918 for accommodating a SIC (Subscriber Identity Component) in the form factor of a card Subscriber Identity Module (SIM) or universal SIM 920, and interfacing the SIM card 920 with the processor(s) 902. However, it is to be appreciated that the SIM card 920 can be manufactured into the device 900, and updated by downloading data and software.

The device 900 can process IP data traffic through the communication component 910 to accommodate IP traffic from an IP network such as, for example, the Internet, a corporate intranet, a home network, a person area network, etc., through an ISP or broadband cable provider. Thus, VoIP traffic can be utilized by the device 900 and IP-based multimedia content can be received in either an encoded or a decoded format.

A video processing component 922 (e.g., a camera) can be provided for decoding encoded multimedia content. The video processing component 922 can aid in facilitating the generation, editing, and sharing of video quotes. The device 900 also includes a power source 924 in the form of batteries and/or an AC power subsystem, which power source 924 can interface to an external power system or charging equipment (not shown) by a power I/O component 926.

The device 900 can also include a video component 930 for processing video content received and for recording and transmitting video content. For example, the video component 930 can facilitate the generation, editing and sharing of video quotes. A location tracking component 932 facilitates geographically locating the device 900. As described hereinabove, this can occur when the user initiates the feedback signal automatically or manually. A user input component 934 facilitates the user initiating the quality feedback signal. The user input component 934 can also facilitate the generation, editing and sharing of video quotes. The user input component 934 can include such conventional input device technologies such as a keypad, keyboard, mouse, stylus pen, and/or touch screen, for example.

Referring again to the applications 906, a hysteresis component 936 facilitates the analysis and processing of hysteresis data, which is utilized to determine when to associate with the access point. A software trigger component 938 can be provided that facilitates triggering of the hysteresis component 936 when the Wi-Fi transceiver 913 detects the beacon of the access point. A SIP client 940 enables the device 900 to support SIP protocols and register the subscriber with the SIP registrar server. The applications 906 can also include a client 942 that provides at least the capability of discovery, play and storage of multimedia content, for example, music.

The device 900, as indicated above related to the communication component 910, includes an indoor network radio transceiver 913 (e.g., Wi-Fi transceiver). This function supports the indoor radio link, such as IEEE 802.11, for the dual-mode GSM device (e.g., device 900). The device 900 can accommodate at least satellite radio services through a device (e.g., handset device) that can combine wireless voice and digital radio chipsets into a single device (e.g., single handheld device).

It is to be appreciated and understood that one or more components (e.g., the devices, configuration manager component, base station, core network, or other component) of the systems (e.g., system 100, system 400, system 700, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

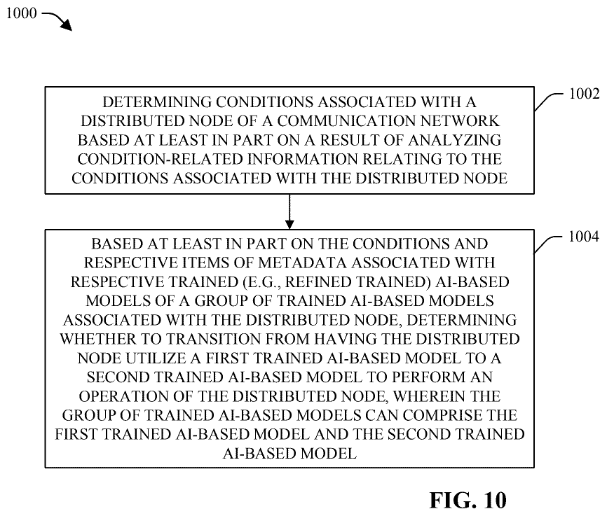

In view of the example systems and/or devices described herein, example methods that can be implemented in accordance with the disclosed subject matter can be further appreciated with reference to flowcharts in FIGS. 10-12. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 10 illustrates a flow chart of an example method 1000 that can desirably (e.g., automatically, dynamically, suitably, reliably, efficiently, enhancedly, and/or optimally) manage and perform selection of a desirable AI-based model from a group of AI-based models associated with a distributed node to perform desired AI-based operations on and for the distributed node, in accordance with various aspects and embodiments of the disclosed subject matter. The method 1000 can be employed by, for example, a system that can comprise the distributed node that can comprise or be associated with the model selector component, the processor component, the data store, and/or other components.

At 1002, conditions associated with a distributed node of a communication network can be determined based at least in part on a result of analyzing condition-related information relating to the conditions associated with the distributed node. In some embodiments, the distributed node, employing the data processor component, can analyze the condition-related information relating to the conditions (e.g., the operational conditions, communication-related conditions, environmental conditions, and/or other conditions) associated with the distributed node. Based at least in part on the result of such analysis, the data processor component (or the model selector component of the distributed node) can determine the conditions associated with the distributed node.

At 1004, based at least in part on the conditions and respective items of metadata associated with respective trained (e.g., refined, customized, adapted, or node-specific trained) AI-based models of a group of trained AI-based models associated with the distributed node, a determination can be made regarding whether to transition from having the distributed node utilize a first trained AI-based model to a second trained AI-based model to perform an operation of the distributed node, wherein the group of trained AI-based models can comprise the first trained AI-based model and the second trained AI-based model. In certain embodiments, based at least in part on the conditions and the respective items of metadata associated with the respective trained AI-based models of the group of trained AI-based models (e.g., group of trained AI-based model variants), the model selector component can determine whether to transition from having the distributed node utilize the first trained AI-based model to the second trained AI-based model to perform the operation of the distributed node, in accordance with the defined model management criteria, which can comprise the defined distributed node performance criteria relating to determining and selecting a desirable (e.g., most suitable, enhanced, or optimal) trained AI-based model from the group of of trained AI-based models associated with the distributed node.

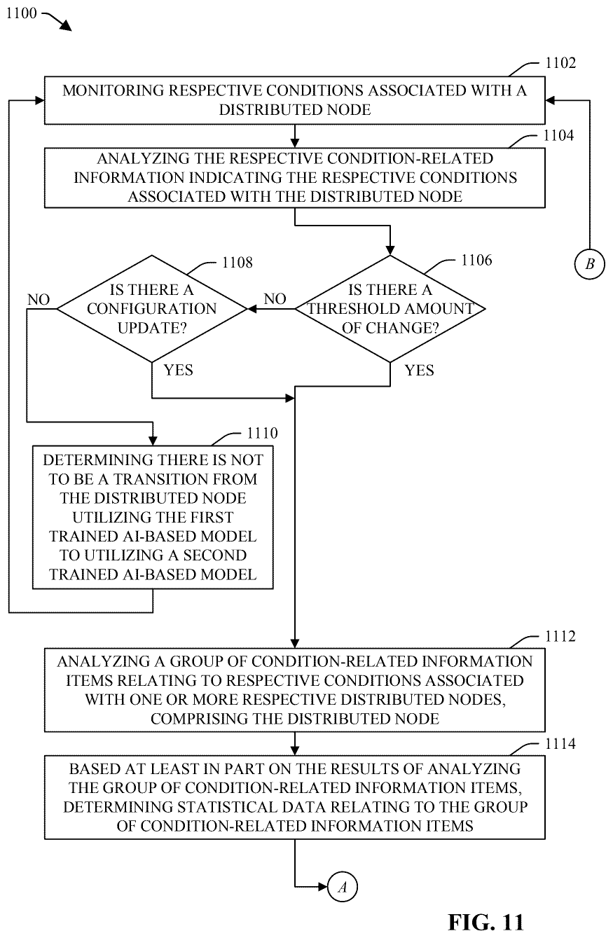

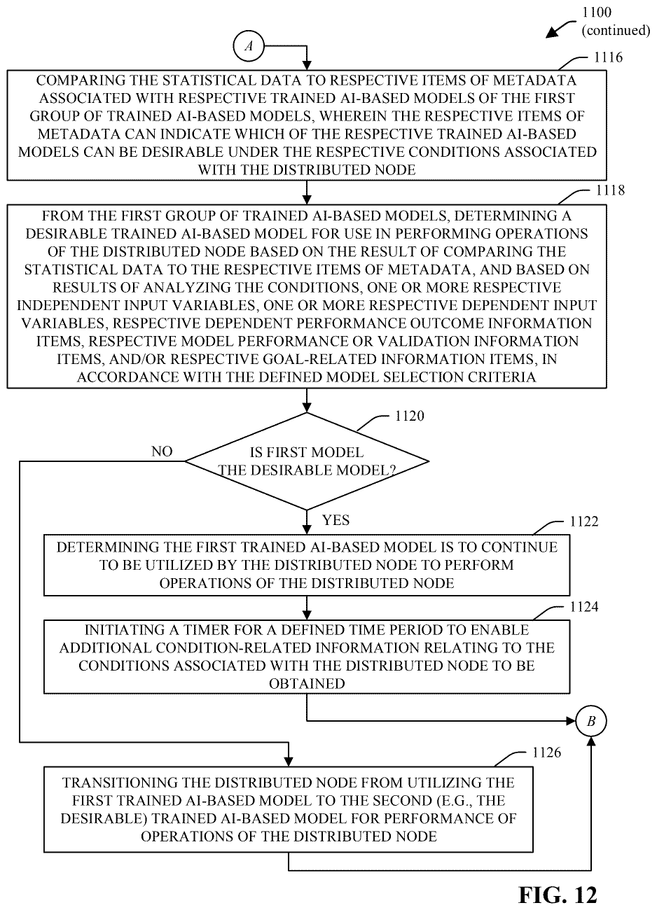

FIGS. 11-12 depict a flow chart of another example method 1100 that can desirably (e.g., automatically, dynamically, suitably, reliably, efficiently, enhancedly, and/or optimally) manage and perform selection of a desirable AI-based model from a group of AI-based models associated with a distributed node to perform desired AI-based operations on and for the distributed node, in accordance with various aspects and embodiments of the disclosed subject matter. The method 1100 can be employed by, for example, a system that can comprise the distributed node, which can comprise the model selector component, data collector component, and data processor component, and also can comprise or be associated with the processor component, the data store, and/or other components.

At 1102, respective conditions associated with a distributed node can be monitored. For instance, the distributed node, employing the data collector component, can monitor the respective conditions (e.g., the operational conditions, communication-related conditions, data traffic and processing load-related conditions, environmental conditions, and/or other conditions) associated with the distributed node. Based at least in part on the monitoring, the data collector component can receive (e.g., obtain or collect) respective condition-related information relating to the respective conditions.

At 1104, the respective condition-related information indicating the respective conditions associated with the distributed node can be analyzed. For instance, the data processor component can analyze the respective condition-related information to facilitate determining the respective conditions associated with the distributed node.

At 1106, based at least in part on the respective conditions, a determination can be made regarding whether there is a threshold amount of change in the respective conditions associated with the distributed node. In some embodiments, the distributed node, employing the model selector component, can determine whether there is the threshold amount of change in the respective conditions associated with the distributed node (e.g., can determine whether a threshold for triggering model reselection has been breached), based at least in part on the respective conditions determined as the result of such analyzing.

If it is determined that the threshold amount of change in the respective conditions has not occurred or is not detected, at 1108, a determination can be made regarding whether there is a configuration update that relates to a first trained AI-based model that is being utilized by the distributed node. In certain embodiments, if the model selector component determines that the threshold amount of change in the conditions has not occurred or is not detected based at least in part on the respective conditions and the applicable threshold amount of change, the model selector component can determine whether there is a configuration update (e.g., configuration update to modify configuration relating to performance enhancement goals or other type of configuration update) that relates to the first trained AI-based model (e.g., first refined trained AI-based model) that is being utilized by the distributed node.

If it is determined that there is no configuration update that relates to the first trained AI-based model, at 1110, a determination can be made that there is not to be a transition from the distributed node utilizing the first trained AI-based model to utilizing a second trained AI-based model, of a first group of trained AI-based models associated with the distributed node, for performance of operations of the distributed node, and monitoring of the respective conditions associated with the distributed node can continue. In some embodiments, if the model selector component determines that there is no configuration update that relates to the first trained AI-based model, the model selector component can determine that there is not to be a transition from the distributed node utilizing the first trained AI-based model to the second trained AI-based model (e.g., second refined trained AI-based model), of the first group of trained (e.g., refined, customized, adapted, or node-specific trained) AI-based models associated with the distributed node, for performance of operations of the distributed node, and can determined that the monitoring of the respective conditions associated with the distributed node can continue to be performed. At this point, the method 1100 can return to reference numeral 1102, and the method 1100 can continue from that point.

Referring again to reference numeral 1108, if, instead, at 1108, it is determined that there is a configuration update that relates to the first trained AI-based model that is being utilized by the distributed node, the method 1100 can proceed to reference numeral 1112, and the method 1100 can proceed from that point, such as described herein. In some embodiments, if the model selector component determines that there is a configuration update that relates to the first trained AI-based model that is being utilized by the distributed node, the model selector component can continue to perform certain operations (e.g., can proceed to reference numeral 1112 of the method 1100) to determine whether there is to be a transition from the distributed node utilizing the first trained AI-based model to the second trained AI-based model of the first group of trained AI-based models.

Referring again to reference numeral 1106, if, instead, at 1106, it is determined that the threshold amount of change in the respective conditions associated with the distributed node has occurred or has been detected, the method 1100 can proceed to reference numeral 1112, and the method 1100 can proceed from that point, such as described herein. In some embodiments, if the model selector component determines that the threshold amount of change in the respective conditions associated with the distributed node has occurred or has been detected, the model selector component can continue to perform certain operations (e.g., can proceed to reference numeral 1112 of the method 1100) to determine whether there is to be a transition from the distributed node utilizing the first trained AI-based model to the second trained AI-based model of the first group of trained AI-based models.

In response to determining that the threshold amount of change in the respective conditions has occurred, or in response to determining that there is a configuration update that relates to the first trained AI-based model, at 1112, a group of condition-related information items relating to respective conditions associated with one or more respective distributed nodes, comprising the distributed node, can be analyzed. In certain embodiments, the distributed node, employing the data processor component (or another component of the distributed node), can analyze the group of condition-related information items relating to the respective conditions associated with one or more respective distributed nodes, comprising the distributed node.

At 1114, based at least in part on the results of analyzing the group of condition-related information items, statistical data relating to the group of condition-related information items can be determined, wherein at least one of the statistical data or the group of condition-related information items may have been utilized to facilitate training and validation of the first group of trained AI-based models or a second group of trained AI-based models comprising the first group of trained AI-based models, and wherein the second group of trained AI-based models can be associated with the one or more respective distributed nodes (e.g., the distributed node or a group (e.g., cluster) of distributed nodes comprising the distributed node). In some embodiments, based at least in part on the results of analyzing the group of condition-related information items, the data processor component (or another component of the distributed node) can determine (e.g., calculate) the statistical data relating to the group of condition-related information items. At this point, the method 1100 can proceed to reference point A, wherein the method 1100 can continue from reference point A, as depicted in FIG. 12 and described herein.

At 1116, the statistical data can be compared to respective items of metadata associated with respective trained AI-based models of the first group of trained AI-based models, wherein the respective items of metadata can indicate which of the respective trained AI-based models can be desirable (e.g., can be the most suitable, enhanced, or optimal) under the respective conditions associated with the distributed node. In certain embodiments, the model selector component can compare (e.g., evaluate) the statistical data relating to the group of condition-related information items to the respective items of metadata associated with the respective trained AI-based models of the first group of trained AI-based models.

At 1118, from the first group of trained AI-based models, a desirable trained AI-based model for use in performing the operations of the distributed node can be determined based at least in part on the result of comparing the statistical data to the respective items of metadata, and based at least in part on results of analyzing the conditions, one or more respective independent input variables, one or more respective dependent input variables, respective dependent performance outcome information items, respective model performance or validation information items, and/or respective goal-related information items that can indicate one or more performance goals associated with model selection, in accordance with the defined model selection criteria. In some embodiments, from the first group of trained AI-based models, the model selector component can determine the desirable (e.g., the most suitable, enhanced, or optimal) trained AI-based model, which can be utilized to perform the desired operations of the distributed node, based at least in part on the result (e.g., comparison result) of comparing the statistical data to the respective items of metadata (e.g., comprising the respective artifacts relating or corresponding to the respective performance enhancement goals) associated with the respective trained AI-based models, and based at least in part on the conditions, the one or more respective independent input variables, the one or more respective dependent input variables, the respective dependent performance outcome information items, the respective model performance or validation information items, and/or the respective goal-related information, in accordance with the defined model selection criteria, which can comprise the distributed node and/or model performance enhancement (e.g., optimization) criteria.

At 1120, a determination can be made regarding whether the first trained AI-based model is the desirable trained AI-based model. In certain embodiments, the model selector component can determine whether the first trained AI-based model (e.g., the model currently utilized by the distributed node) is the desirable trained AI-based model to utilize to perform the desired operations of the distributed node.

If it is determined that the first trained AI-based model is the desirable trained AI-based model, at 1122, a determination can be made that the first trained AI-based model is to continue to be utilized by the distributed node to perform operations of the distributed node. At 1124, a timer for a defined time period can be initiated to enable additional condition-related information relating to the conditions associated with the distributed node to be obtained. For instance, if the model selector component determines that the first trained AI-based model is the desirable trained AI-based model, the model selector component can determine that the first trained AI-based model is to continue to be utilized by the distributed node to perform operations of the distributed node. In response to determining that the first trained AI-based model is to continue to be utilized by the distributed node, the model selector component can initiate (e.g., start or set) a timer for the defined time period to enable additional condition-related information relating to the conditions associated with the distributed node to be obtained (e.g., collected and analyzed), and, accordingly, can determine that monitoring of the respective conditions associated with the distributed node can continue. At this point, the method 1100 can proceed to reference point B, wherein the method 1100 can return to reference numeral 1102 of FIG. 10, wherein such monitoring can be performed, and the method 1100 can continue from that point.

Referring again to reference numeral 1120, if, instead, it is determined that the first trained AI-based model is not the desirable trained AI-based model (e.g., if it is determined the second trained AI-based model is the desirable trained AI-based model), at 1126, the distributed node can transition from utilizing the first trained AI-based model to the second (e.g., the desirable) trained AI-based model for performance of operations of the distributed node. In some embodiments, if the model selector component determine that the second trained AI-based model is the desirable trained AI-based model (e.g., in accordance with the defined distributed node performance criteria, the model selector component can transition from having the distributed node utilize the first trained AI-based model to utilizing the second (e.g., the desirable) trained AI-based model for performance of operations of the distributed node. At this point, the method 1100 can proceed to reference point B, wherein the method 1100 can return to reference numeral 1102 of FIG. 10, wherein monitoring of the respective conditions associated with the distributed node can continue to be monitored, and the method 1100 can continue from that point.

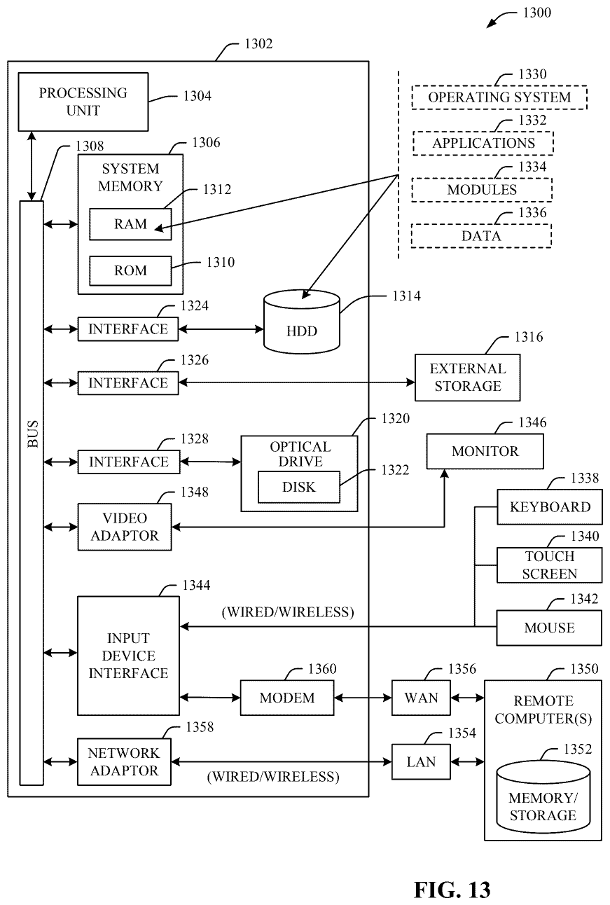

In order to provide additional context for various embodiments described herein, FIG. 13 and the following discussion are intended to provide a brief, general description of a suitable computing environment 1300 in which the various embodiments of the embodiments described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 also can be configured for external use in a suitable chassis (not shown). Additionally, while not shown in environment 1300, a solid state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can also be connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are examples and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356, e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., device, UE, communication network, core network, RAN, distributed node, data collector component, data processor component, model selector component, central node, distributed training node, central unit, distributed unit, radio unit, model or AI-based model, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
determining, by a system comprising at least one processor, conditions associated with a distributed node of a communication network based on a result of analyzing condition-related information relating to the conditions associated with the distributed node; and
based on the conditions and respective items of metadata associated with respective trained artificial intelligence-based models of a group of trained artificial intelligence-based models associated with the distributed node, determining, by the system, whether to transition from having the distributed node utilize a first trained artificial intelligence-based model to a second trained artificial intelligence-based model to perform an operation of the distributed node, wherein the group of trained artificial intelligence-based models comprises the first trained artificial intelligence-based model and the second trained artificial intelligence-based model.

2. The method of claim 1, wherein the respective items of metadata indicate which of the respective trained artificial intelligence-based models is to be utilized under respective conditions associated with the distributed node, wherein the respective items of metadata comprise or relate to respective descriptor information that describes respective characteristics of the respective trained artificial intelligence-based models to facilitate model selection, and wherein the determining of whether to transition comprises:
based on the conditions, the respective items of metadata, one or more respective independent input variables, one or more respective dependent input variables, respective dependent performance outcome information items, respective threshold change-related information items, respective model performance or validation information items, or respective goal-related information items indicating at least one performance goal associated with the model selection, determining whether to transition from having the distributed node utilize the first trained artificial intelligence-based model to the second trained artificial intelligence-based model to perform the operation of the distributed node.

3. The method of claim 1, further comprising:
monitoring, by the system, the conditions associated with the distributed node;
analyzing, by the system, the condition-related information indicating the conditions associated with the distributed node; and
based on the result of the analyzing of the condition-related information, determining, by the system, whether a threshold amount of change in the conditions has occurred.

4. The method of claim 3, further comprising:
in response to determining that the threshold amount of change in the conditions has not occurred or is not detected, determining, by the system, whether there is a configuration update that relates to the first trained artificial intelligence-based model,
wherein the determining of whether to transition from having the distributed node utilize the first trained artificial intelligence-based model to the second trained artificial intelligence-based model to perform the operation of the distributed node comprises:
one of:
in response to determining that there is no configuration update, determining, by the system, that no transition from having the distributed node utilize the first trained artificial intelligence-based model to the second trained artificial intelligence-based model is to be performed, and the monitoring of the conditions associated with the distributed node is to continue to be performed; or
in response to determining that there is the configuration update, determining, by the system, which of the respective trained artificial intelligence-based models of the group of trained artificial intelligence-based models is to be selected to perform the operation of the distributed node.

5. The method of claim 3, wherein the determining of whether to transition from having the distributed node utilize the first trained artificial intelligence-based model to the second trained artificial intelligence-based model to perform the operation of the distributed node comprises:
in response to determining that the threshold amount of change in the conditions has occurred, determining, by the system, which of the respective trained artificial intelligence-based models of the group of trained artificial intelligence-based models is to be selected to perform the operation of the distributed node.

6. The method of claim 1, wherein the group of trained artificial intelligence-based models is a first group of trained artificial intelligence-based models, wherein the result is a first result, and wherein the method further comprises:
in response to determining that the threshold amount of change in the conditions has occurred, or in response to determining that there is a configuration update that relates to the first trained artificial intelligence-based model, analyzing, by the system, a group of condition-related information items relating to respective conditions associated with one or more respective distributed nodes, comprising the distributed node;
based on a second result of the analyzing of the group of condition-related information items, determining, by the system, statistical data relating to the group of condition-related information items, wherein at least one of the statistical data or the group of condition-related information items was utilized to facilitate training and validation of the first group of trained artificial intelligence-based models or a second group of trained artificial intelligence-based models comprising the first group of trained artificial intelligence-based models, and wherein the second group of trained artificial intelligence-based models is associated with the one or more respective distributed nodes;
comparing, by the system, the statistical data to the respective items of metadata associated with the respective trained artificial intelligence-based models of the group of trained artificial intelligence-based models, wherein the respective items of metadata indicate which of the respective trained artificial intelligence-based models is to be utilized under the respective conditions associated with the distributed node; and
from the first group of trained artificial intelligence-based models, and based on a third result of the comparing and a defined distributed node performance criterion, determining, by the system, which of the respective trained artificial intelligence-based models of the first group of trained artificial intelligence-based models satisfies the defined distributed node performance criterion and is to be selected to perform the operation of the distributed node.

7. The method of claim 6, further comprising:
from the first group of trained artificial intelligence-based models, determining, by the system, whether the first trained artificial intelligence-based model satisfies the defined distributed node performance criterion and is to be utilized to perform the operation of the distributed node.

8. The method of claim 7, further comprising:
in response to determining that the first trained artificial intelligence-based model satisfies the defined distributed node performance criterion and is to be utilized to perform the operation of the distributed node, determining, by the system, that the first trained artificial intelligence-based model is to continue to be utilized by the distributed node to perform the operation of the distributed node;
initiating, by the system, a timer for a defined time period to enable additional condition-related information relating to the conditions associated with the distributed node to be obtained; and
determining, by the system, that the monitoring of the conditions associated with the distributed node is to continue to be performed.

9. The method of claim 6, further comprising:
in response to determining that the second trained artificial intelligence-based model satisfies the defined distributed node performance criterion and is to be selected to perform the operation of the distributed node, determining, by the system, that there is to be the transition from having the distributed node utilize the first trained artificial intelligence-based model to the second trained artificial intelligence-based model to perform the operation of the distributed node; and
transitioning, by the system, from the distributed node utilizing the first trained artificial intelligence-based model to the second trained artificial intelligence-based model to perform the operation of the distributed node.

10. The method of claim 1, further comprising:
in response to determining that there is to be the transition from having the distributed node utilize the first trained artificial intelligence-based model to the second trained artificial intelligence-based model to perform the operation of the distributed node, retrieving, by the system, the second trained artificial intelligence-based model from a first model repository of the distributed node or a second model repository of a central node associated with the distributed node.

11. The method of claim 1, further comprising:
in response to determining that there is to be the transition from having the distributed node utilize the first trained artificial intelligence-based model to the second trained artificial intelligence-based model to perform the operation of the distributed node, managing, by the system, synchronizing and triggering of the transition from having the distributed node utilize the first trained artificial intelligence-based model to the second trained artificial intelligence-based model to perform the operation of the distributed node to have the transition occur without disruption of mission-mode operational performance of the distributed node.

12. The method of claim 1, wherein the first trained artificial intelligence-based model is a refined trained artificial intelligence-based model, wherein an artificial intelligence-based model is trained, based on a first group of training data relating to a group of distributed nodes comprising the distributed node, to generate a trained artificial intelligence-based model, and wherein the trained artificial intelligence-based model is trained, based on a second group of training data relating to the distributed node, to generate the refined trained artificial intelligence-based model that is tailored to account for the conditions and characteristics associated with the distributed node in connection with the refined trained artificial intelligence-based model at least one of performing the operation of the distributed node or generating artificial intelligence-based output result data.

13. A system, comprising:
at least one memory that stores computer executable components; and
at least one processor that executes computer executable components stored in the at least one memory, wherein the computer executable components comprise:
a data processor that determines conditions associated with a distributed node of a communication network based on a result of an analysis of condition-related data relating to the conditions associated with the distributed node; and
a model selector that, based on the conditions and respective items of metadata associated with respective trained artificial intelligence-based models of a group of trained artificial intelligence-based models associated with the distributed node, determines whether to switch from having the distributed node utilize a first trained artificial intelligence-based model to a second trained artificial intelligence-based model to perform an operation of the distributed node, wherein the group of trained artificial intelligence-based models comprises the first trained artificial intelligence-based model and the second trained artificial intelligence-based model.

14. The system of claim 13, wherein the computer executable components comprise:
a data collector that monitors the conditions associated with the distributed node and obtains the condition-related data, wherein the condition-related data indicates the conditions associated with the distributed node, and
wherein, based on the conditions, the model selector determines whether a threshold amount of change in the conditions exists.

15. The system of claim 13, wherein the group of trained artificial intelligence-based models is a first group of trained artificial intelligence-based models, wherein the result is a first result,
wherein, based on determining that the threshold amount of change in the conditions exists, or based on determining that there is a configuration update that relates to the first trained artificial intelligence-based model, the model selector compares statistical data relating to a group of condition-related information items to the respective items of metadata associated with the respective trained artificial intelligence-based models of the group of trained artificial intelligence-based models,
wherein the group of condition-related information items relate to respective conditions associated with one or more respective distributed nodes, comprising the distributed node, wherein the respective items of metadata indicate which of the respective trained artificial intelligence-based models is to be utilized under the respective conditions associated with the distributed node, wherein at least one of the statistical data or the group of condition-related information items was utilized to facilitate training and validation of the first group of trained artificial intelligence-based models or a second group of trained artificial intelligence-based models comprising the first group of trained artificial intelligence-based models, wherein the second group of trained artificial intelligence-based models is associated with the one or more respective distributed nodes, and
wherein, from the first group of trained artificial intelligence-based models, and based on a third result of the comparison and a defined distributed node performance criterion, the model selector determines which of the respective trained artificial intelligence-based models of the first group of trained artificial intelligence-based models satisfies the defined distributed node performance criterion and is to be selected to perform the operation of the distributed node.

16. The system of claim 15, wherein, from the first group of trained artificial intelligence-based models, the model selector determines whether the first trained artificial intelligence-based model satisfies the defined distributed node performance criterion and is to be utilized to perform the operation of the distributed node, and
wherein, based on determining that the first trained artificial intelligence-based model satisfies the defined distributed node performance criterion and is to be utilized to perform the operation of the distributed node, the model selector determines that the first trained artificial intelligence-based model is to continue to be utilized by the distributed node to perform the operation of the distributed node, initiates a timer for a defined length of time to enable additional condition-related data relating to the conditions associated with the distributed node to be collected, and determines that monitoring of the conditions associated with the distributed node is to continue to be performed.

17. The system of claim 15, wherein, based on determining that the second trained artificial intelligence-based model satisfies the defined distributed node performance criterion and is to be selected to perform the operation of the distributed node, the model selector determines that there is to be the switch from having the distributed node utilize the first trained artificial intelligence-based model to the second trained artificial intelligence-based model to perform the operation of the distributed node, and initiates the switch from the distributed node utilizing the first trained artificial intelligence-based model to the second trained artificial intelligence-based model to perform the operation of the distributed node.

18. The system of claim 13, wherein the distributed node is, comprises, is part of, or is associated with, a radio unit or a distributed unit of a radio access network, or is part of, or is associated with, a communication network other than a cellular or wireless communication network, wherein the radio access network is a disaggregated radio access network, and wherein the disaggregated radio access network comprises the distributed unit located in a first location, a central unit located in the first location or a second location, and the radio unit located in the first location, the second location, or a third location.

19. A non-transitory machine-readable medium, comprising executable instructions that, when executed by at least one processor, facilitate performance of operations, comprising:
determining conditions associated with a distributed node of a group of distributed nodes of a communication network based on a result of evaluating condition-related data relating to the conditions associated with the distributed node; and
based on the conditions and respective metadata items associated with respective trained artificial intelligence-based models of a group of trained artificial intelligence-based models associated with the distributed node, determining whether to transition from having the distributed node utilize a first trained artificial intelligence-based model to a second trained artificial intelligence-based model to perform an operation of the distributed node, wherein the group of trained artificial intelligence-based models comprises the first trained artificial intelligence-based model and the second trained artificial intelligence-based model, and wherein the respective metadata items indicate which of the respective trained artificial intelligence-based models is to be utilized under the conditions associated with the distributed node.

20. The non-transitory machine-readable medium of claim 19, wherein the operations further comprise:
monitoring the conditions associated with the distributed node;
analyzing the condition-related data indicating the conditions associated with the distributed node;
based on the result of the analyzing of the condition-related data, determining whether a threshold amount of change in the conditions exist;
in response to determining that the threshold amount of change in the conditions exists, and based on the respective metadata items, determining, from the group of trained artificial intelligence-based models, which of the respective trained artificial intelligence-based models of the group of trained artificial intelligence-based models satisfies a defined distributed node performance criterion and is to be selected to perform the operation of the distributed node; and
in response to determining that the second trained artificial intelligence-based model satisfies the defined distributed node performance criterion and is to be selected to perform the operation of the distributed node, initiating the transition from the distributed node utilizing the first trained artificial intelligence-based model to the second trained artificial intelligence-based model to perform the operation of the distributed node.
